(19) United States
(12) Patent Application Publication
(10) Pub. No.: US 2026/0098952 A1
(43) Pub. Date: Apr. 9, 2026

(54) ON-VEHICLE SENSOR DEVICE

(71) Applicant: DENSO CORPORATION, Kariya-city (JP)

(72) Inventors: Yu KOYAMA, Nisshin-city (JP); Hirotaka KOYAMA, Kariya-city (JP); Ryoma NIIHARA, Kariya-city (JP); Yoshihiro HIROHASHI, Kariya-city (JP)

(21) Appl. No.: 19/413,891

(22) Filed: Dec. 9, 2025

Related U.S. Application Data
(63) Continuation of application No. PCT/JP2024/017892, filed on May 15, 2024.

(30) Foreign Application Priority Data
Jun. 12, 2023 (JP) 2023-096457

(51) Int. Cl. G01S 7/521; G01S 15/931; G01S 15/08

(52) U.S. Cl. CPC G01S 7/521; G01S 15/931; G01S 15/08

(57) ABSTRACT

An on-vehicle sensor device to be mounted on a vehicle includes an ultrasonic sensor, a sensor housing, and a sound vibration sensor. The ultrasonic sensor includes a transceiver configured to perform at least one of reception or transmission of an ultrasonic wave. The sensor housing houses at least a part of the ultrasonic sensor. The sound vibration sensor is configured to detect a sound or vibration in an audible range. The sensor housing houses the sound vibration sensor in addition to the ultrasonic sensor. The sound vibration sensor is disposed separately from the transceiver on a back side of the transceiver. The sensor housing defines a hollow space between the sound vibration sensor and the transceiver.

### CROSS REFERENCE TO RELATED APPLICATION

The present application is a continuation application of International Patent Application No. PCT/JP2024/017892 filed on May 15, 2024, which designated the U.S. and claims the benefit of priority from Japanese Patent Application No. 2023-096457 filed on June 12, 2023. The entire disclosures of all the above applications are incorporated herein by reference.

### TECHNICAL FIELD

The disclosure in the specification relates to an on-vehicle sensor device installed in a vehicle.

### BACKGROUND ART

There is a transducer array that is mounted on a vehicle and enables the measurement of the distance between surrounding objects and the vehicle.

### SUMMARY

One disclosed aspect of the present disclosure provides an on-vehicle sensor device to be mounted on a vehicle, and the on-vehicle sensor device includes an ultrasonic sensor, a sensor housing, and a sound vibration sensor. The ultrasonic sensor includes a transceiver configured to perform at least one of reception and transmission of an ultrasonic wave. The sensor housing houses at least a part of the ultrasonic sensor. The sound vibration sensor detects a sound or vibration in an audible range. The sensor housing may house the sound vibration sensor in addition to the ultrasonic sensor. The sound vibration sensor may be disposed separately from the transceiver on a back side of the transceiver, and the sensor housing may define a hollow space between the sound vibration sensor and the transceiver.

### BRIEF DESCRIPTION OF DRAWINGS

FIG. 1 is a diagram illustrating examples of a location where an on-vehicle sensor device of the present disclosure is installed.

FIG. 2 is a longitudinal cross-sectional view showing the configuration of an on-vehicle sensor device according to the first embodiment of the present disclosure.

FIG. 3 is a diagram showing the electrical configuration of an object detection system including the on-vehicle sensor device and an ECU.

FIG. 4 is a diagram for explaining a method of installing the on-vehicle sensor device on a vehicle.

FIG. 5 is a longitudinal cross-sectional view showing the configuration of an on-vehicle sensor device according to the second embodiment of the present disclosure.

FIG. 6 is a longitudinal cross-sectional view showing the configuration of an on-vehicle sensor device according to the third embodiment of the present disclosure.

FIG. 7 is a longitudinal cross-sectional view showing the configuration of an on-vehicle sensor device according to the fourth embodiment of the present disclosure.

FIG. 8 is a longitudinal cross-sectional view showing the configuration of an on-vehicle sensor device according to the fifth embodiment of the present disclosure.

FIG. 9 is a longitudinal cross-sectional view showing the configuration of an on-vehicle sensor device according to the sixth embodiment of the present disclosure.

FIG. 10 is a longitudinal cross-sectional view showing the configuration of an on-vehicle sensor device according to the seventh embodiment of the present disclosure.

FIG. 11 is a longitudinal cross-sectional view showing the configuration of an on-vehicle sensor device according to the eighth embodiment of the present disclosure.

FIG. 12 is a longitudinal cross-sectional view showing the configuration of an on-vehicle sensor device according to the ninth embodiment of the present disclosure.

FIG. 13 is a longitudinal cross-sectional view showing the configuration of an on-vehicle sensor device according to the tenth embodiment of the present disclosure.

FIG. 14 is a longitudinal cross-sectional view showing the configuration of an on-vehicle sensor device according to the eleventh embodiment of the present disclosure.

FIG. 15 is a longitudinal cross-sectional view showing the configuration of an on-vehicle sensor device according to the twelfth embodiment of the present disclosure.

FIG. 16 is a longitudinal cross-sectional view showing the configuration of an on-vehicle sensor device according to the thirteenth embodiment of the present disclosure.

FIG. 17 is a longitudinal cross-sectional view showing the configuration of an on-vehicle sensor device according to the fourteenth embodiment of the present disclosure.

FIG. 18 is a longitudinal cross-sectional view showing the configuration of an on-vehicle sensor device according to the fifteenth embodiment of the present disclosure.

FIG. 19 is a longitudinal cross-sectional view showing the configuration of an on-vehicle sensor device according to the sixteenth embodiment of the present disclosure.

FIG. 20 is a longitudinal cross-sectional view showing the configuration of an on-vehicle sensor device according to the seventeenth embodiment of the present disclosure.

FIG. 21 is a longitudinal cross-sectional view showing the configuration of an on-vehicle sensor device according to the eighteenth embodiment of the present disclosure.

FIG. 22 is a longitudinal cross-sectional view showing the configuration of an on-vehicle sensor device according to the nineteenth embodiment of the present disclosure.

FIG. 23 is a longitudinal cross-sectional view showing the configuration of an on-vehicle sensor device according to the twentieth embodiment of the present disclosure.

FIG. 24 is a longitudinal cross-sectional view showing the configuration of an on-vehicle sensor device according to the twenty-first embodiment of the present disclosure.

### DESCRIPTION OF EMBODIMENTS

To begin with, examples of relevant techniques will be described.

There is a transducer array mounted on a vehicle. The transducer array enables the measurement of the distance between surrounding objects and the vehicle by transmitting and receiving acoustic signals such as ultrasonic waves.

Acoustic signals include not only ultrasonic waves, but also audible sounds and vibrations. There is ongoing consideration of mounting a sound vibration sensor capable of detecting the audible sounds or vibrations on vehicles. However, when a sound vibration sensor is mounted on a vehicle separately from an ultrasonic sensor, the complexity of the configuration may increase, making installation more difficult.

The present disclosure provides an on-vehicle sensor device that enables easier installation of a sound vibration sensor in a vehicle.

One disclosed aspect provides an on-vehicle sensor device to be mounted on a vehicle and the on-vehicle sensor device includes an ultrasonic sensor, a sensor housing, and a sound vibration sensor. The ultrasonic sensor includes a transceiver configured to perform at least one of reception and transmission of an ultrasonic wave. The sensor housing houses at least a part of the ultrasonic sensor. The sound vibration sensor detects a sound or vibration in an audible range. The sensor housing houses the sound vibration sensor in addition to the ultrasonic sensor.

In this aspect, the sensor housing for the ultrasonic sensor also accommodates the sound vibration sensor that detects sounds or vibrations. Thus, mounting the ultrasonic sensor on the vehicle and installation of the sound vibration sensor on the vehicle are achieved at the same time. Accordingly, this allows for a simplified configuration compared to an arrangement in which the sound vibration sensor is installed on the vehicle independently of the ultrasonic sensor. Thus, installation of the sound vibration sensor on the vehicle is facilitated.

Hereinafter, multiple embodiments will be described with reference to the drawings. In addition, corresponding components in each embodiment are denoted by the same reference numerals, and redundant descriptions may be omitted. In cases where only a part of the configuration is described in each embodiment, the configuration of other parts may be applied from previously described embodiments. Furthermore, in the descriptions of each embodiment, not only the explicitly stated combinations of configurations, but also, as long as there is no particular hindrance to their combination, configurations from multiple embodiments may be partially combined with each other, even if such combinations are not explicitly described.

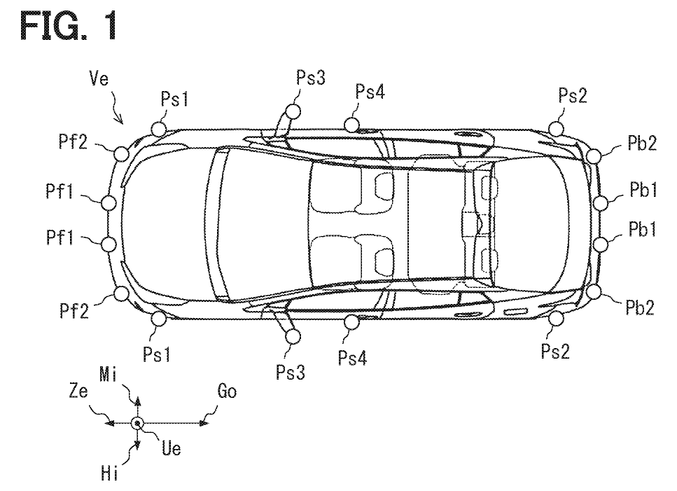

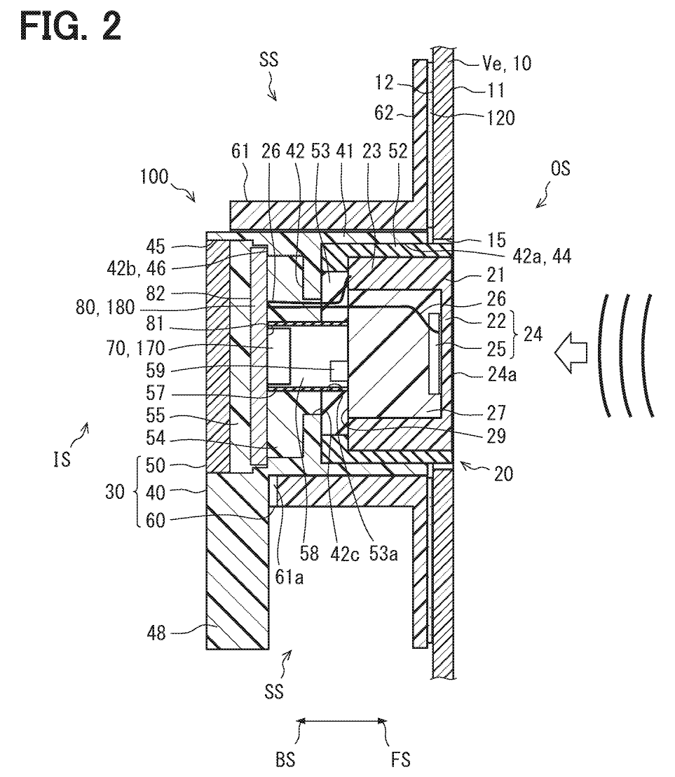

(Mounting Position of Acoustic Sensor Device) An on-vehicle sensor device 100 according to the present disclosure is mounted on a vehicle Ve, as shown in FIGS. 1 and 2. The on-vehicle sensor device 100 can be installed at various locations on the vehicle Ve, such as the front, sides, or rear of the vehicle Ve. The on-vehicle sensor device 100 is held on an external structure 10 of the vehicle Ve, which has a plate-like shape. The on-vehicle sensor device 100 has a ultrasonic transmission reception surface 24a exposed to an outside of the vehicle Ve.

The external structure 10 on the front of the vehicle is, for example, a center portion Pf1 or a corner portion Pf2 of the front bumper. The on-vehicle sensor device 100 installed on the external structure 10 at the front of the vehicle is oriented with the transmission reception surface 24a facing in a forward direction (Ze) of the vehicle Ve, and is mainly used to detect objects located in front of the vehicle Ve.

The external structure 10 on the side of the vehicle is, for example, a front bumper side portion Ps1, a rear bumper side portion Ps2, a side mirror cover Ps3, or a side step Ps4. The on-vehicle sensor device 100 installed on the external structure 10 on the side of the vehicle is oriented with the transmission reception surface 24a facing in a right direction Mi or in a left direction Hi of the vehicle Ve, and is mainly used to detect objects located on the lateral sides of the vehicle Ve.

The external structure 10 on the rear of the vehicle is, for example, a center portion Pb1 or a corner portion Pb2 of the rear bumper. The on-vehicle sensor device 100 installed on the external structure 10 at the rear of the vehicle is oriented with the transmission reception surface 24a facing in a rearward direction (Go) of the vehicle Ve and is mainly used to detect objects located in the rearward direction (Go) of the vehicle Ve.

Here, the longitudinal (front-rear) and lateral (left-right) directions in the present disclosure are defined with reference to the vehicle Ve at rest on a horizontal plane. Specifically, the longitudinal direction (the forward direction Ze and the rearward direction Go) is defined along the longitudinal axis (traveling direction) of the vehicle Ve. The lateral direction (the right direction Mi and the left direction Hi) is defined along the width direction of the vehicle Ve. Furthermore, the vertical direction (an upward direction Ue) is defined along the vertical axis relative to the horizontal plane specified by the longitudinal and lateral directions. For the sake of simplification, the symbols indicating each direction may be omitted as appropriate in the following description.

(First Embodiment) As shown in FIG. 2, an on-vehicle sensor device 100 according to the first embodiment of the present disclosure includes an ultrasonic microphone 20 that transmits and receives ultrasonic waves, and a sound vibration sensor 70 that detects sounds or vibrations in an audible range. Ultrasonic waves are sound waves with a high frequency that cannot be heard by the human ear. Specifically, ultrasonic waves are sound waves of 20 kHz or higher. The audible range is a frequency band lower than that of ultrasonic waves. Specifically, the audible range is the range from 20 Hz to 20 kHz. The on-vehicle sensor device 100, the external structure 10, and an adhesive layer 120 form an on-vehicle sensor installation structure.

The external structure 10 is, for example, a front bumper or rear bumper, and is formed into a flat plate shape or a slightly curved plate shape from a resin material such as polypropylene. The external structure 10 has a vehicle outer surface 11 that is exposed to the outside of the vehicle Ve with facing in the forward direction Ze, the rearward direction Go, or the lateral direction of the vehicle Ve. In the external structure 10, the back side of the vehicle outer surface 11 serves as a smooth vehicle inner surface 12 to which the adhesive layer 120 is attached. The external structure 10 defines a mounting opening 15. The mounting opening 15 is a flat through-hole that passes through the external structure 10 in a plate thickness direction of the external structure 10. The transmission reception surface 24a of the on-vehicle sensor device 100 is exposed to a front side of the vehicle outer surface 11 through the mounting opening 15.

The adhesive layer 120 is formed by double-sided tape, adhesive, or the like. The adhesive layer 120 is formed as a thin film that is thinner than the external structure 10. Both surfaces of the adhesive layer 120 are bonded to the vehicle inner surface 12 and the on-vehicle sensor device 100, respectively. The on-vehicle sensor device 100 is fixed to the vehicle inner surface 12 by the adhesive layer 120.

In the following description, the direction in which the vehicle outer surface 11 and the transmission reception surface 24a face is referred to as a front side FS, and the direction in which the vehicle inner surface 12 faces is referred to as a back side BS. In addition, the space on the front side FS relative to the external structure 10 is referred to as an outer space OS, the space on the back side BS of a back surface (i.e., a back cover 50) of the on-vehicle sensor device 100 is referred to as an inner space IS, and the space surrounding the on-vehicle sensor device 100 is referred to as a side space SS. The outer space OS is the space outside of the vehicle where ultrasonic waves and audible sounds arrive. The inner space IS is the space located inside the vehicle Ve. The side space SS is the space located above, below, on the left, and on the right of the on-vehicle sensor device 100 along the vehicle inner surface 12.

(Configuration of On-Vehicle Sensor Device) The on-vehicle sensor device 100 includes the ultrasonic microphone 20, a sensor housing 30, a sound vibration sensor 70, and a circuit board 80.

The ultrasonic microphone 20 is configured to transmit and receive ultrasonic waves. The ultrasonic microphone 20 emits an ultrasonic probe wave toward the outer space OS. The ultrasonic microphone 20 receives the probe wave (reflected wave) reflected by an object present in the outer space OS, and outputs a detection signal corresponding to the result of receiving the reflected wave. The ultrasonic microphone 20 includes a microphone housing 21, a piezoelectric element 25, and a microphone filler 27.

The microphone housing 21 is made of a metallic material such as aluminum, and formed in a bottomed cylindrical. The microphone housing 21 has a receiving bottom portion 22 and a side wall portion 23. The receiving bottom portion 22 is formed as a thin plate at the bottom of the microphone housing 21. The piezoelectric element 25 is fixed to an inner surface of the receiving bottom portion 22. The receiving bottom portion 22 functions as a diaphragm. The receiving bottom portion 22 and the piezoelectric element 25 form a transceiver 24 that performs at least one of receiving and transmitting ultrasonic waves. The outer surface of the receiving bottom portion 22 serves as the transmission reception surface 24a that is exposed to the outer space OS when the on-vehicle sensor device 100 is attached to the external structure 10. The side wall portion 23 is formed in a cylindrical shape surrounding the periphery of the receiving bottom portion 22.

The piezoelectric element 25 is formed in a thin-film shape. The piezoelectric element 25 is housed in an internal space of the microphone housing 21, which is defined (enclosed) by the receiving bottom portion 22 and the side wall portion 23. The piezoelectric element 25 is electrically connected to the circuit board 80 via a microphone lead wire 26. The piezoelectric element 25 generates minute vibrations based on input electrical signals, enabling emission of ultrasonic waves (probe waves) from the transceiver 24. The piezoelectric element 25 converts vibrations of ultrasonic waves (echoes) arriving at the transceiver 24 into electrical signals, enabling detection of reflected waves.

The internal space of the microphone housing 21 is filled with the microphone filler 27 that is formed from a material such as silicone rubber that is cured within the internal space or foamed urethane. The microphone filler 27 covers the transceiver 24 from the back side BS of the transceiver 24 and seals the piezoelectric element 25. The microphone filler 27 and the end surface of the side wall portion 23 on the back side BS of the side wall portion 23 form a back surface (hereinafter referred to as the microphone back surface 29) of the ultrasonic microphone 20.

The sensor housing 30 accommodates components such as the ultrasonic sensor, the sound vibration sensor 70, and the circuit board 80. The sensor housing 30 includes a housing main body 40, the back cover 50, and a retainer 60.

The housing main body 40 is formed in a box shape from a resin material such as polybutylene terephthalate (PBT). The housing main body 40 includes a housing peripheral wall 41, an intermediate partition wall 42, and a connector connection portion 48.

The housing peripheral wall 41 is formed in a cylindrical shape. The housing peripheral wall 41 includes a microphone support portion 44, a cover fixing portion 45, and a board fixing portion 46. The microphone support portion 44 is formed on a part of an inner surface of the housing peripheral wall 41 that is on the front side FS of the intermediate partition wall 42. The microphone support portion 44 supports the ultrasonic microphone 20 via a cushion 52 (described later). The cover fixing portion 45 is formed on an end part of the inner surface of the housing peripheral wall 41 that faces the back side BS. The cover fixing portion 45 holds the back cover 50. The board fixing portion 46 is a stepped surface formed on the inner surface of the housing peripheral wall 41. The board fixing portion 46 is formed between the cover fixing portion 45 and the intermediate partition wall 42, in a position facing the back side BS. The board fixing portion 46 supports the circuit board 80 from the front side FS.

The intermediate partition wall 42 is erected inward from the inner surface of the housing peripheral wall 41. The intermediate partition wall 42 divides the internal space of the housing main body 40 into a microphone accommodating chamber 42a and a board accommodating chamber 42b. The microphone accommodating chamber 42a is defined on the front side FS of the intermediate partition wall 42. The microphone accommodating chamber 42a accommodates at least a part of the ultrasonic microphone 20. The board accommodating chamber 42b is defined on the back side BS of the intermediate partition wall 42. The board accommodating chamber 42b accommodates the circuit board 80 and the back cover 50. The intermediate partition wall 42A defines a connection opening 42c. The connection opening 42c is a flat through-hole that passes through the intermediate partition wall 42 in the plate thickness direction of the intermediate partition wall 42. The connection opening 42c fluidly connects the microphone accommodating chamber 42a and the board accommodating chamber 42b.

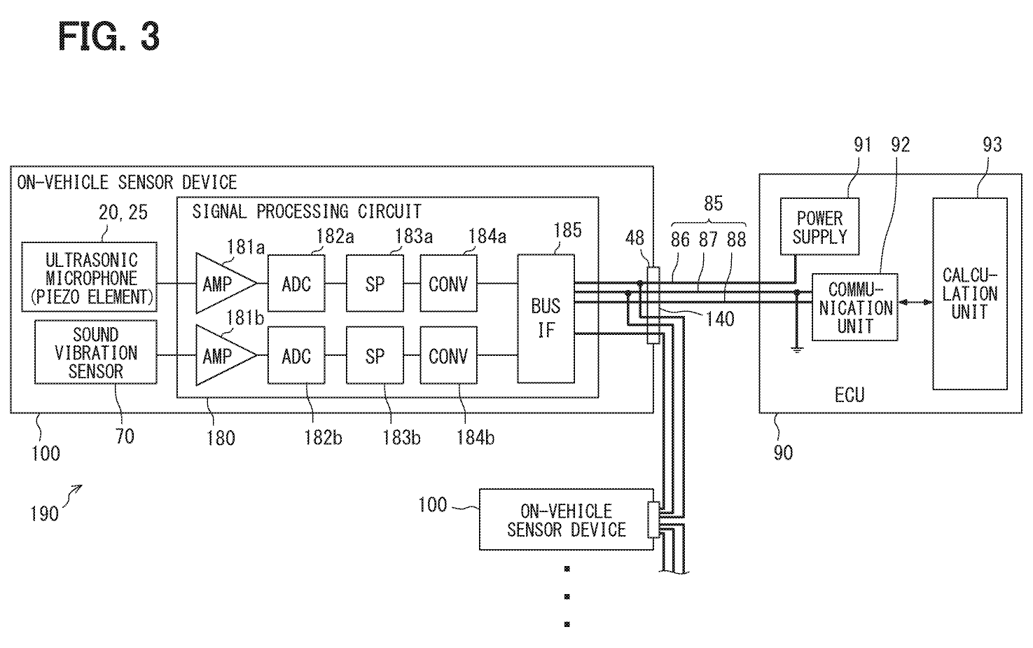

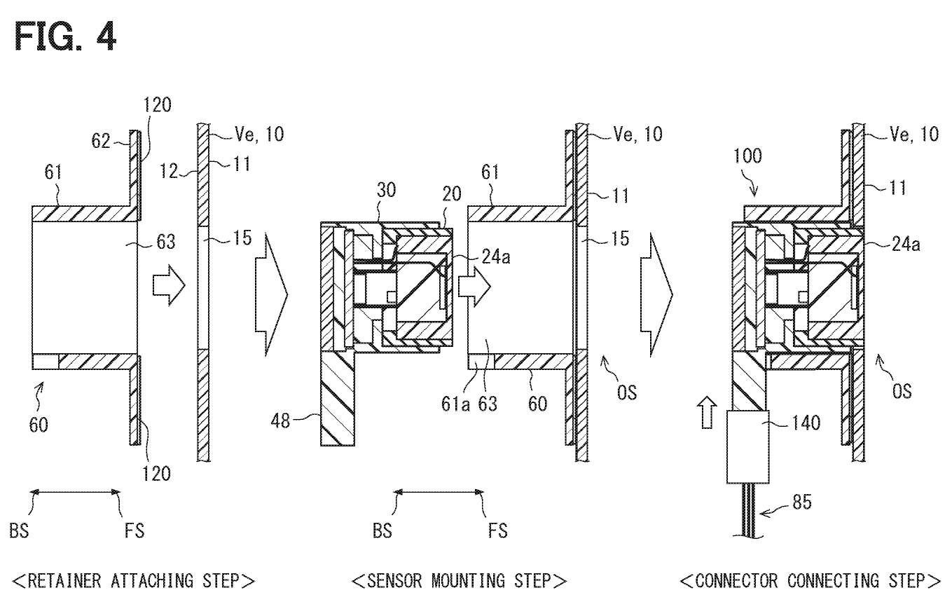

The connector connection portion 48 is provided at a back side end of the housing peripheral wall 41 that faces the back side BS. The connector connection portion 48 is erected in a tubular shape from an outer surface of the housing peripheral wall 41 along the vehicle inner surface 12. The connector connection portion 48 may be inclined toward the back side BS with respect to the vehicle inner surface 12. Inside the connector connection portion 48, terminal pins which are electrically connected to the circuit board 80 are exposed. To the connector connection portion 48, a connector 140 (see FIG. 4) for electrically connecting the circuit board 80 to an external ECU 90 (see FIG. 3) is connected.

The housing main body 40 accommodates the ultrasonic microphone 20, the sound vibration sensor 70, the circuit board 80, the cushion 52, a damper 53, a front filler 54, a back filler 55, a viscoelastic tube 57, and a moisture absorbent 59.

The cushion 52 and the damper 53 elastically support the ultrasonic microphone 20 with respect to the housing main body 40 such that sound and vibration can be transmitted from the ultrasonic microphone 20 to an air layer 58 (described later). The cushion 52 is formed in a cylindrical (O-ring) shape from a filling and curing type silicone rubber or the like. The cushion 52 may be formed by injection molding. The cushion 52 is housed in the microphone accommodating chamber 42a. The cushion 52 is sandwiched between the microphone support portion 44 of the housing peripheral wall 41 and the side wall portion 23 of the microphone housing 21. The cushion 52 is disposed in a radially compressed (flattened) state.

The damper 53 is formed in a thick plate shape from sponge or foamed rubber. The damper 53 defines a damper opening 53a. The damper opening 53a is a through-hole that passes through the central portion of the damper 53 in the plate thickness direction of the damper 53. The damper 53 is positioned inward of the cushion 52, and is housed in the microphone accommodating chamber 42a. The damper 53 is disposed in a compressed state in the plate thickness direction of the damper 53 between the intermediate partition wall 42 and the microphone back surface 29.

The board accommodating chamber 42b is filled with the front filler 54 and the back filler 55 which are formed from a viscoelastic material, such as silicone rubber that is cured within the board accommodating chamber 42b or foamed urethane. The front filler 54 and the back filler 55 seal the sound vibration sensor 70 and the circuit board 80. At least one of the front filler 54 and the back filler 55 may be formed of a porous, low-elasticity material such as sponge. The front filler 54 is filled in the connection opening 42c and a space of the board accommodating chamber 42b defined on the front side FS of the circuit board 80. The back filler 55 is filled in a space on the back side BS of the circuit board 80, in other words, in the space between the circuit board 80 and the back cover 50.

The viscoelastic tube 57 is formed in a cylindrical shape from a viscoelastic material such as silicone rubber. The viscoelastic tube 57 functions as a sound conduit (acoustic path tube). The back end of the viscoelastic tube 57 that faces the back side BS is in contact with a front mounting surface 81 of the circuit board 80. The front end of the viscoelastic tube 57 that faces the front side FS is in contact with the microphone back surface 29 of the ultrasonic microphone 20. The viscoelastic tube 57 is disposed between the front mounting surface 81 and the microphone back surface 29 in a state of being slightly compressed in the axial direction of the viscoelastic tube 57.

The viscoelastic tube 57 defines therein the air layer 58. The air layer 58 is defined in a space inside the housing peripheral wall 41 (the front filler 54) and on the front side FS of the circuit board 80 facing the transceiver 24. The air layer 58 is a hollow space defined between the sound vibration sensor 70 and the transceiver 24. The air layer 58 (the air in the air layer 58) transmits sound and vibrations arriving at the transceiver 24 from the microphone back surface 29 to the sound vibration sensor 70.

The moisture absorbent 59 is formed from a porous material such as silica gel. The moisture absorbent 59 is disposed inside the air layer 58 and absorbs water vapor (moisture) generated within the air layer 58. In other words, the moisture absorbent 59 suppresses the occurrence of condensation in the air layer 58. The moisture absorbent 59 may be attached to the microphone back surface 29, or may be applied to the microphone back surface 29. The amount of the moisture absorbent 59 disposed inside the air layer 58 is determined according to the volume of the air layer 58, and the larger the volume of the air layer 58, the greater the amount used.

The back cover 50 is formed from a resin material such as polypropylene. The back cover 50 has an overall rectangular plate shape that is larger than the circuit board 80. The back cover 50 is internally fitted into the cover fixing portion 45 while compressing the back filler 55 between the back cover 50 and the circuit board 80. The back cover 50 is joined to the cover fixing portion 45 by adhesion or welding. The back filler 55 may function as an adhesive, thereby allowing the back cover 50 to be fixed to the housing main body 40. The back cover 50 is positioned on the back side BS of the circuit board 80 and the back filler 55. The back cover 50 and the housing main body 40 form the sealed board accommodating chamber 42b.

The retainer 60 is formed in a flanged, flat cylindrical shape from a resin material such as PBT. The retainer 60 holds the housing main body 40 with respect to the external structure 10. The retainer 60 includes a surrounding wall 61 that encloses the housing main body 40, and a retaining portion 62 that is held by the external structure 10. The surrounding wall 61 is formed thicker than the housing peripheral wall 41 of the housing main body 40. The surrounding wall 61 holds the housing main body 40 by being externally fitted onto the housing peripheral wall 41. The surrounding wall 61 defines a notch 61a. The notch 61a is a recessed portion provided in the surrounding wall 61 to avoid the connector connection portion 48 that protrudes outward from the outer peripheral wall of the housing main body 40. The retaining portion 62 is a flange-shaped portion that protrudes outward from the front end of the surrounding wall 61 that faces the front side FS. The retaining portion 62 is attached to the vehicle inner surface 12 via an adhesive layer 120 formed by double-sided tape or adhesive.

The sound vibration sensor 70 is housed in the sensor housing 30 together with the ultrasonic microphone 20. The sound vibration sensor 70 is arranged separately from the transceiver 24 on the back side BS of the transceiver 24. The sound vibration sensor 70 detects sound or vibration in the audible range. The sound vibration sensor 70 includes a MEMS (Micro Electro Mechanical Systems) microphone 170.

The MEMS microphone 170 is a microphone element that converts sound or vibration in the audible range into an electrical signal. The MEMS microphone 170 functions as a condenser microphone that outputs, as an electrical signal (detection signal), changes in capacitance of a thin vibrating membrane (membrane) that vibrates in response to sound pressure. The MEMS microphone 170 is mounted on the front mounting surface 81 of the circuit board 80. The MEMS microphone 170 is housed inward the viscoelastic tube 57 and is in contact with the air layer 58. The MEMS microphone 170 detects sounds or vibrations in the audible range that arrive at the ultrasonic microphone 20 from outside the vehicle Ve and are transmitted to the air layer 58. It should be noted that, instead of the MEMS microphone 170, an electret condenser microphone or the like can be employed as an audible sound microphone element of the sound vibration sensor 70.

The circuit board 80 is made of a glass epoxy board or the like, and has an overall rectangular plate shape. The circuit board 80 is housed in the board accommodating chamber 42b and is fixed to the board fixing portion 46 in a posture aligned with the receiving bottom portion 22. The circuit board 80 is attached to the board fixing portion 46 by a double-sided tape or adhesive. The circuit board 80 may also be fixed to the housing main body 40 by utilizing the back filler 55 as an adhesive.

The circuit board 80 includes the front mounting surface 81 and a back mounting surface 82 on both sides. The front mounting surface 81 is a mounting surface that faces the front side FS. The front mounting surface 81 mounts the MEMS microphone 170. To the front mounting surface 81, a microphone lead wire 26 drawn from the ultrasonic microphone 20 is connected. The back mounting surface 82 is a mounting surface that faces the back side BS. The back mounting surface 82 is connected to terminal pins and the like. On the circuit board 80, a signal processing circuit 180 (see FIG. 3) which is electrically connected to the piezoelectric element 25 and the MEMS microphone 170 is formed.

(Electrical Configuration of Object Detection System Using On-Vehicle Sensor Device) An object detection system 190 is an on-vehicle system that detects the relative position, size, relative speed, and the like of objects present around the vehicle Ve. The object detection system 190 includes multiple on-vehicle sensor devices 100 and the ECU 90. Hereinafter, the details of the electrical configurations of the on-vehicle sensor devices 100 and the ECU 90 will be described with reference to FIGS. 2 and 3.

The on-vehicle sensor device 100 is connected to the ECU 90 and other on-vehicle sensor devices 100 via external connection lines 85. Each of the external connection lines 85 is formed by a wire harness or the like. In the on-vehicle sensor device 100, a connection line (hereinafter, a first connection line) for electrically connecting the sound vibration sensor 70 to the ECU 90 is shared with a connection line (hereinafter, a second connection line) for electrically connecting the ultrasonic microphone 20 to the ECU 90. That is, the external connection lines 85 serving as the first connection line also serve as the second connection line. In other words, the external connection lines 85 have both the functions of the first connection line and the second connection line.

The external connection lines 85 include a power supply line 86, a GND line 87, and a communication line 88. The power supply line 86 supplies a power supply voltage to each of the on-vehicle sensor devices 100. The GND line 87 supplies a ground voltage to each of the on-vehicle sensor devices 100. The communication line 88 forms a communication bus that enables data communication between the on-vehicle sensor devices 100 and the ECU 90. For communication connections between the on-vehicle sensor devices 100 and the ECU 90, communication buses based on data communication standards such as LIN, DSI3, and CAN (registered trademark) are used. Additionally, a communication bus based on high-speed serial communication standards such as LVDS, Ethernet (registered trademark), or A2B may be used for communication connections between the on-vehicle sensor devices 100 and the ECU 90.

The circuit board 80 of the on-vehicle sensor device 100 includes the signal processing circuit 180. The signal processing circuit 180 is electrically connected to the piezoelectric element 25 of the ultrasonic microphone 20 and to the sound detection element (such as the MEMS microphone 170) of the sound vibration sensor 70. The signal processing circuit 180 processes output signals (detection signals) from the ultrasonic microphone 20 and the sound vibration sensor 70, and outputs the respective detection results to the ECU 90. The functions of the signal processing circuit 180 may be provided by a single dedicated chip such as an ASIC, or by an electric circuit formed by combining multiple IC chips.

The signal processing circuit 180 includes amplifiers 181a and 181b, AD converters 182a and 182b, signal processing units 183a and 183b, converters 184a and 184b, and a bus interface 185. The amplifier 181a, AD converter 182a, signal processing unit 183a, and converter 184a are connected to the piezoelectric element 25 and are configured to process the output signal from the piezoelectric element 25. The converter 184a provides the detection result of the ultrasonic microphone 20 to the bus interface 185.

The amplifier 181b, AD converter 182b, signal processing unit 183b, and converter 184b are connected to the sound vibration sensor 70, and are configured to process the output signal from the sound vibration sensor 70. The converter 184b converts the output signal from the sound vibration sensor 70 into feature information, specifically, information such as a spectrum indicating the power for each frequency. The converter 184b compresses the data size to be transferred to the ECU 90 by converting the output signal into feature quantities. The converter 184b provides the feature quantities (spectrum information) to the bus interface 185.

The bus interface 185 is connected to the ECU 90 for communication with the ECU 90 via the communication line 88. The bus interface 185 transfers both the detection results (sonar results) from the ultrasonic microphone 20 and the feature quantities (audible sound feature quantities) based on the detection results from the sound vibration sensor 70 to the ECU 90 via the communication bus (communication line 88). In a configuration where high-speed communication is possible between the signal processing circuit 180 and the ECU 90, RAW data before conversion into feature quantities, in other words, digitally converted, uncompressed digital signals, may be transferred from the bus interface 185 to the ECU 90.

The ECU 90 is an on-board computer installed in the vehicle Ve and is an external device provided outside the sensor housing 30. The ECU 90 may be a dedicated ECU that processes the detection results of the on-vehicle sensor devices 100, or may be an integrated ECU equipped with other functions. The ECU 90 is electrically connected to the on-vehicle sensor devices 100. The ECU 90 includes a power supply unit 91, a communication unit 92, and a calculation unit 93.

The power supply unit 91 is connected to each of the on-vehicle sensor devices 100 via the power supply line 86. The power supply unit 91 supplies the electric power necessary for ultrasonic and audible sound detection operations to each of the on-vehicle sensor devices 100. The communication unit 92 serves as a bus master and is connected to each of the on-vehicle sensor devices 100 via the communication line 88. The communication unit 92 receives detection results and feature quantities transmitted by each of the signal processing circuits 180. The communication unit 92 provides the received detection results and feature quantities to the calculation unit 93. The calculation unit 93 is, for example, a processing unit mainly comprising a microcontroller. The calculation unit 93 generates object information such as the relative position, size, and relative speed of objects around the vehicle, based on the detection results and feature quantities acquired from the communication unit 92.

(Method for Mounting On-Vehicle Sensor Device) Next, the details of the method for mounting the on-vehicle sensor device 100 onto the external structure 10 will be explained with reference to FIGS. 2 and 4. The method for mounting the on-vehicle sensor device 100 includes a retainer attaching step, a sensor mounting step, and a connector connecting step in this order.

In the retainer attaching step, the retainer 60 is attached to the external structure 10 after a mounting opening 15 is defined in the external structure 10. In the configuration where double-sided tape is used as the adhesive layer 120, one adhesive surface of the adhesive layer 120 is attached to an attachment surface of the retaining portion 62, which faces the front side FS. Then, the other attachment surface of the adhesive layer 120 is attached to the vehicle inner surface 12 in a state where the center of a retaining space 63 defined inside the surrounding wall 61 is matched with the center of the mounting opening 15. Through the above steps, the retainer 60 is fixed to the external structure 10.

In the sensor mounting step, the sensor housing 30 is mounted to the retainer 60. The sensor housing 30 is inserted into the retaining space 63 from the back side BS, with the transceiver 24 oriented toward the front side FS. The sensor housing 30 is internally fitted into the surrounding wall 61 with the connector connection portion 48 oriented to be accommodated in the notch 61a. By mounting the sensor housing 30 to the retainer 60, the transmission reception surface 24a of the ultrasonic microphone 20 is exposed to the outer space OS through the mounting opening 15, and becomes substantially flush with the vehicle outer surface 11. In the sensor mounting step, the on-vehicle sensor device 100 is physically fixed to the external structure 10.

In the connector connecting step, the connector 140 is fitted to the connector connection portion 48. To the connector 140, multiple external connection lines 85, including the power supply line 86, the GND line 87, and the communication line 88, are connected. The attachment of the connector 140 to the connector connection portion 48 establishes electrical connection between the on-vehicle sensor device 100 and other devices such as the ECU 90 and other on-vehicle sensor devices 100.

(Summary of First Embodiment) In the first embodiment described so far, the sensor housing 30 for the ultrasonic microphone 20 also houses the sound vibration sensor 70 that detects sounds or vibrations. Thus, by mounting the ultrasonic microphone 20 on the vehicle Ve, the sound vibration sensor 70 can also be mounted on the vehicle Ve. Accordingly, a simpler configuration can be achieved compared to the mode in which the sound vibration sensor 70 is mounted on the vehicle Ve as a structure independent from the ultrasonic microphone 20. Thus, mounting the sound vibration sensor 70 on the vehicle Ve becomes easier.

More specifically, the number of person-hours required for installation on the vehicle Ve, such as forming the mounting opening 15, attaching the retainer 60, and connecting the connector 140, can be reduced compared to the configuration in which the ultrasonic microphone 20 and the sound vibration sensor 70 are mounted separately. As a result, mounting multiple sound vibration sensors 70 on the vehicle Ve becomes easy.

In addition, in the first embodiment, the sound vibration sensor 70 is housed in the sensor housing 30 and is disposed on the back side BS of the external structure 10. Thus, sounds or vibrations coming from the outer space OS can be transmitted to the sound vibration sensor 70 through the ultrasonic microphone 20 without passing through the external structure 10 (such as a front bumper). Accordingly, detection of sound or vibration by the sound vibration sensor 70 becomes less susceptible to the characteristics of the external structure 10. That is, separation of the sound vibration detection from the external structure 10 reduces dependence of the sensor characteristics on the vehicle model, grade, and the like. As a result, it becomes possible to easily guarantee the characteristics of the shipped on-vehicle sensor device 100 by performing inspection and adjustment at a sensor factory where the on-vehicle sensor device 100 is manufactured.

In addition, in the first embodiment, the sound vibration sensor 70 is disposed on the back side BS of the transceiver 24, separately from the transceiver 24. Thus, the configuration where the sound vibration sensor 70 is provided separately from the transceiver 24 makes the characteristics of the sound vibration sensor 70 less susceptible to the influence of the ultrasonic microphone 20. As a result, it becomes possible to appropriately adjust the characteristics of the sound vibration sensor 70 at the sensor factory or the like.

Furthermore, the air layer 58 is defined between the sound vibration sensor 70 and the transceiver 24 in the sensor housing 30 of the first embodiment. With such a configuration, sound or vibration input to the transceiver 24 is transmitted to the air layer 58, and the sound vibration sensor 70 can detect the vibration of the air inside the air layer 58. Accordingly, the detection sensitivity for sound or vibration in the audible range using a condenser microphone is improved.

In addition, in the first embodiment, the circuit board 80 is housed in the sensor housing 30, and the sound vibration sensor 70 includes the MEMS microphone 170 that is mounted on the surface of the circuit board 80. According to the configuration in which the MEMS microphone 170 is mounted on the surface of the circuit board 80, wiring for electrically connecting the sound vibration sensor 70 and the circuit board 80 can be omitted. As a result, the configuration of the on-vehicle sensor device 100 can be further simplified.

In the first embodiment, the viscoelastic tube 57 formed in a cylindrical shape from a viscoelastic material defines the air layer 58 between the transceiver 24 and the circuit board 80 (on the front side FS of the circuit board 80). Such configuration can absorb dimensional variations between the circuit board 80 and the microphone back surface 29 through deformation of the viscoelastic tube 57 when defining the air layer 58 between the circuit board 80 and the microphone back surface 29.

Furthermore, since the end of the viscoelastic tube 57 are pressed against the back mounting surface 82 of the circuit board 80, it becomes difficult for uncured filler to penetrate inward the viscoelastic tube 57.

Furthermore, in the first embodiment, the moisture absorbent 59 that absorbs water vapor in the air layer 58 is disposed inside the air layer 58. Thus, condensation within the air layer 58 caused by temperature changes around the on-vehicle sensor device 100 is less likely to occur. As a result, it becomes less likely that moisture from condensation will adhere to the sound vibration sensor 70 and gradually change the characteristics of the sound vibration sensor 70.

In addition, in the first embodiment, the first connection line for electrically connecting the sound vibration sensor 70 to the ECU 90 is shared with the second connection line for electrically connecting the ultrasonic microphone 20 to the ECU 90. The external connection lines 85 that are commonly used between the sound vibration sensor 70 and the ultrasonic microphone 20 simplify the configuration and reduce the cost compared to a configuration in which the first connection line and the second connection line are provided individually.

In the first embodiment, the common communication line 88 between the ultrasonic microphone 20 and the sound vibration sensor 70 is achieved by bus communication connecting the on-vehicle sensor device 100 and the ECU 90 via a communication bus. Thus, the configuration for connecting the on-vehicle sensor device 100 to the ECU 90 can be further simplified.

In the first embodiment, the output signal of the sound vibration sensor 70 is converted into feature quantity information by the converter 184b. Then, the feature quantity information is transferred to the ECU 90. With the above configuration, the data transferred to the ECU 90 can be compressed. As a result, real-time data transfer from the external structure 10 to the ECU 90 becomes possible without a high-speed communication bus. Such feature quantity information is not limited to the aforementioned spectrum and may be modified as appropriate.

In the above first embodiment, the ultrasonic microphone 20 corresponds to an “ultrasonic sensor,” the microphone filler 27 corresponds to a “filling covering,” and the microphone back surface 29 corresponds to a “back surface.” In addition, the air layer 58 corresponds to a “hollow space,” the circuit board 80 corresponds to a “sensor substrate,” each of the external connection lines 85 corresponds to a “first connection line” and a “second connection line,” the ECU 90 corresponds to an “external device,” and the converter 184b corresponds to an “output converter.”

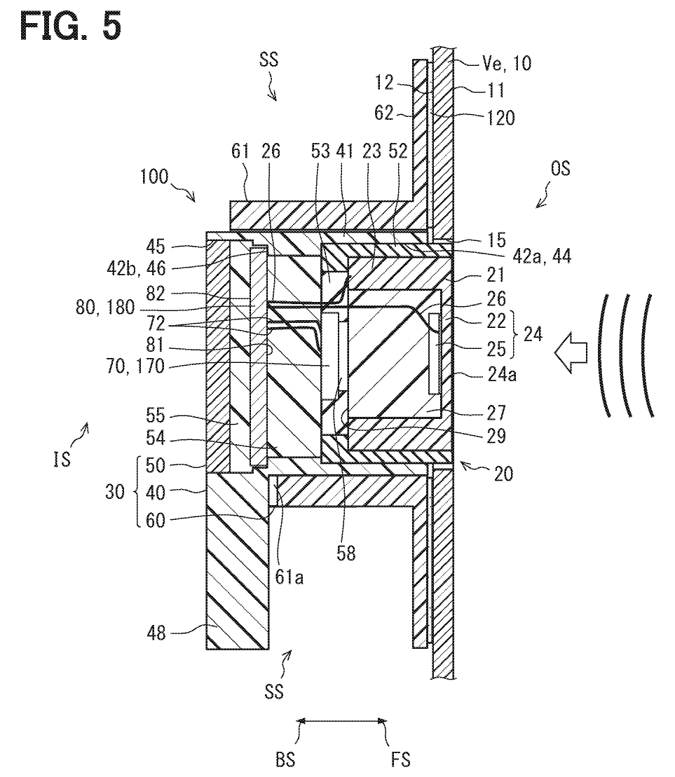

(Second Embodiment) An on-vehicle sensor device 100 of the second embodiment shown in FIG. 5 is a modification of the first embodiment. In the second embodiment, the sound vibration sensor 70 is not mounted on the surface of the circuit board 80 and is disposed at a position separated from the circuit board 80. The sound vibration sensor 70 has a configuration including a MEMS microphone 170 or an electret condenser microphone, as in the first embodiment. The sound vibration sensor 70 has a sensor lead wire 72. The sensor lead wire 72 is an electrical wire drawn out from a main body of the sound vibration sensor 70 toward the back side BS, and is embedded in the front filler 54 together with the microphone lead wire 26. The sensor lead wire 72 is connected to the front mounting surface 81 by soldering. The sound vibration sensor 70 is electrically connected to the circuit board 80 via the sensor lead wire 72.

The sound vibration sensor 70 is indirectly supported by the housing main body 40. Here, being indirectly supported by the housing main body 40 means being supported by the housing main body 40 via a member having a higher modulus of elasticity than air. The sound vibration sensor 70 is attached to the front surface of the front filler 54 facing the front side FS, so that the back surface of the sound vibration sensor 70 is secured by the front filler 54. In the housing main body 40 of the second embodiment, the structure corresponding to the intermediate partition wall 42 (see FIG. 2) is omitted.

The air layer 58 is formed in a flat shape between the sound vibration sensor 70 and the microphone back surface 29. The air layer 58 is defined by the sound vibration sensor 70, the microphone back surface 29, and the damper 53. The air inside the air layer 58 transmits audible sound or vibrations input to the ultrasonic microphone 20 to the sound vibration sensor 70.

Also in the second embodiment described thus far, effects similar to those of the first embodiment are achieved, and it is possible to simplify the configuration for installing the sound vibration sensor 70 together with the ultrasonic microphone 20 in the vehicle Ve. As a result, mounting the sound vibration sensor 70 in the vehicle Ve becomes easier.

In addition, in the second embodiment, the sound vibration sensor 70 is indirectly supported by the housing main body 40 of the sensor housing 30. With such a support structure, the sound vibration sensor 70 can reliably detect the sound or vibration transmitted to the air layer 58. As a result, it becomes possible to improve the detection sensitivity for sounds or vibrations in the audible range.

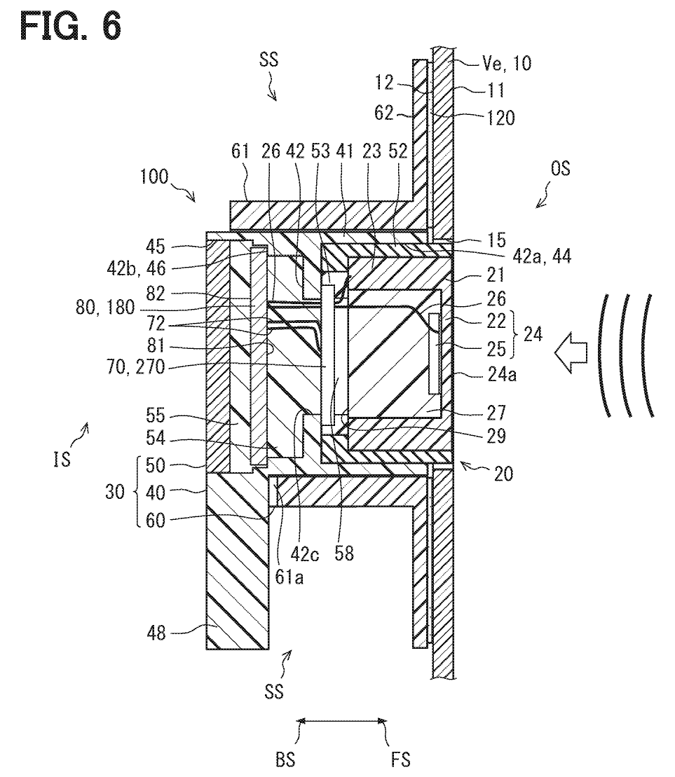

(Third Embodiment) An on-vehicle sensor device 100 of the third embodiment shown in FIG. 6 is a modification of the second embodiment. The sound vibration sensor 70 of the third embodiment has a piezoelectric element 270 as an audible sound microphone element instead of the MEMS microphone 170 (see FIG. 2). The piezoelectric element 270 is laminated with a thin metal plate to form either a unimorph-type diaphragm or a bimorph-type diaphragm. The piezoelectric element 270 is electrically connected to the circuit board 80 via the sensor lead wire 72.

The sound vibration sensor 70 is directly supported by the housing main body 40. The sound vibration sensor 70 is attached to the side surface of the intermediate partition wall 42, which faces the front side FS such that the back side of the sound vibration sensor 70 is secured by the intermediate partition wall 42. The sound vibration sensor 70, the microphone back surface 29, and the damper 53 form an air layer 58. The sound vibration sensor 70 is in contact with the air layer 58. The sound vibration sensor 70 detects audible sound or vibration, which has been transmitted from the ultrasonic microphone 20 to the air in the air layer 58, by the piezoelectric element 270.

Also in the third embodiment, the same effects as in the first and second embodiments are achieved, and it becomes possible to simplify the configuration for mounting the sound vibration sensor 70 together with the ultrasonic microphone 20 on the vehicle Ve.

In addition, in the third embodiment, the sound vibration sensor 70 is directly supported by the housing main body 40 of the sensor housing 30. The support structure in which the sound vibration sensor 70 is fixed to the housing main body 40 enables the sound vibration sensor 70 to reliably detect sound or vibration transmitted to the air layer 58. As a result, it becomes possible to improve the detection sensitivity for sounds or vibrations in the audible range.

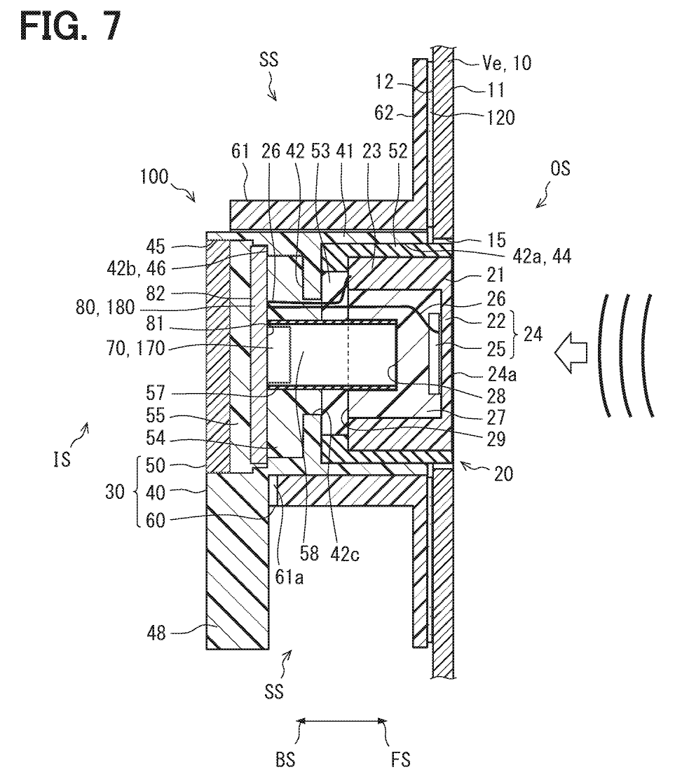

(Fourth Embodiment) An on-vehicle sensor device 100 of the fourth embodiment shown in FIG. 7 is another modified example of the first embodiment. The ultrasonic microphone 20 of the fourth embodiment defines a housing recess 28. The housing recess 28 is formed in the microphone filler 27. The housing recess 28 is a recess recessed from the central portion of the microphone back surface 29 toward the piezoelectric element 25. The housing recess 28 has a shape of a cylindrical hole. Into the housing recess 28, a part of the front portion of the viscoelastic tube 57 that faces the front side is inserted. An inner peripheral surface of the housing recess 28 is fitted around the viscoelastic tube 57. A bottom wall surface of the housing recess 28 and the viscoelastic tube 57 defines the air layer 58. Audible sound or vibration input to the ultrasonic microphone 20 is transmitted to the MEMS microphone 170 through the air inside the air layer 58.

Also in the fourth embodiment, effects similar to those of the first embodiment are achieved, and the configuration for mounting the sound vibration sensor 70 together with the ultrasonic microphone 20 on the vehicle Ve can be simplified.

In addition, in the fourth embodiment, the housing recess 28 that defines at least part of the air layer 58 is formed in the microphone filler 27. The above-described configuration in which a space is defined inside the ultrasonic microphone 20 ensures or increases the volume of the air layer 58 while achieving a thinner on-vehicle sensor device 100. In the fourth embodiment, the housing recess 28 corresponds to a “recess.”

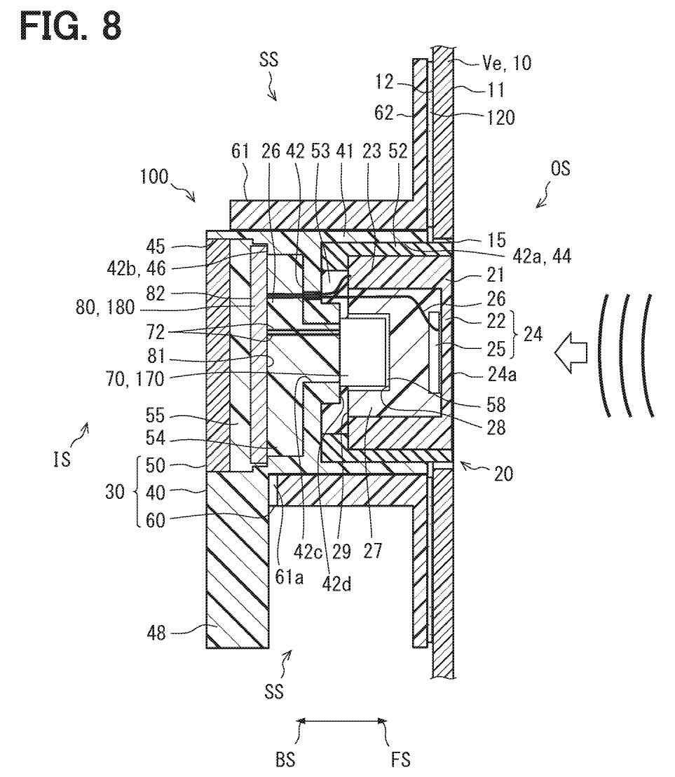

(Fifth Embodiment) An on-vehicle sensor device 100 of the fifth embodiment shown in FIG. 8 is a modification of the fourth embodiment. The housing main body 40 of the fifth embodiment includes a microphone holding protrusion 42d. The microphone holding protrusion 42d is formed on the intermediate partition wall 42. The microphone holding protrusion 42d is erected from the inner edge of the intermediate partition wall 42 facing the connection opening 42c toward the front side FS.

The sound vibration sensor 70 is attached to the top surface of the microphone holding protrusion 42d, which faces the front side FS, and is thereby secured to the microphone holding protrusion 42d. The sound vibration sensor 70 is electrically connected to the circuit board 80 via a sensor lead wire 72. Most of the sound vibration sensor 70 is housed in the housing recess 28 defined in the ultrasonic microphone 20. The air layer 58 is defined between the sound vibration sensor 70 and the inner peripheral surface and bottom wall surface of the housing recess 28. The sound vibration sensor 70 measures, in the housing recess 28, sound or vibration in the audible range transmitted through the air in the air layer 58.

The fifth embodiment also achieves the same effects as the fourth embodiment, and enables simplification of the configuration for mounting the sound vibration sensor 70 together with the ultrasonic microphone 20 on the vehicle Ve. In addition, the configuration in which the housing recess 28 is formed in the ultrasonic microphone 20 and the sound vibration sensor 70 is housed in the housing recess 28 reduces the thickness of the on-vehicle sensor device 100.

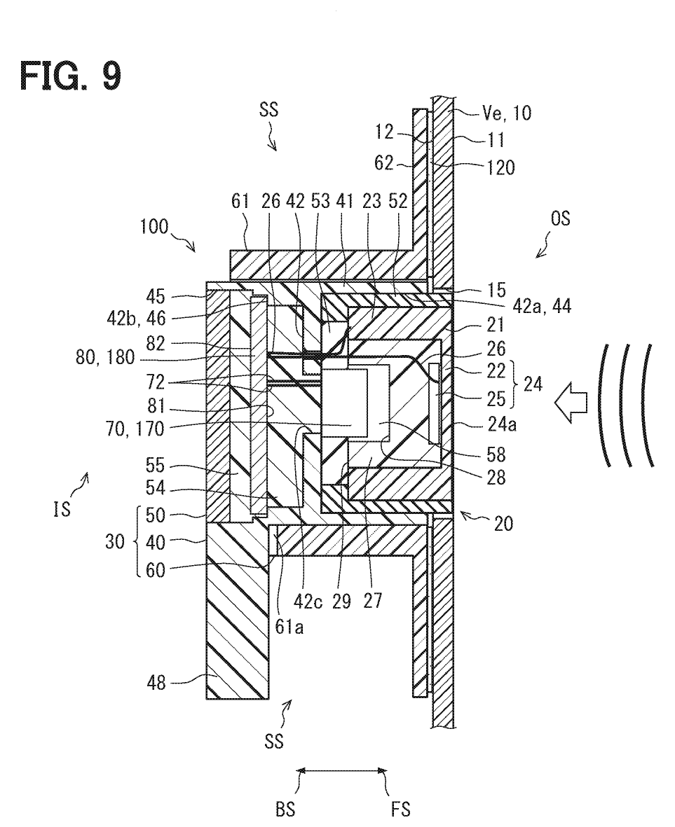

(Sixth Embodiment) The on-vehicle sensor device 100 of the sixth embodiment shown in FIG. 9 is a modification of the fifth embodiment. In the housing main body 40 of the sixth embodiment, the structure corresponding to the microphone holding protrusion 42d (see FIG. 8) is omitted. The sound vibration sensor 70 is supported by the side surface of the intermediate partition wall 42 that faces the front side FS, specifically the inner edge of the side surface of the intermediate partition wall 42 that faces the connection opening 42c. The sound vibration sensor 70 is housed in the housing recess 28 provided in the ultrasonic microphone 20. The air layer 58 is defined between the sound vibration sensor 70 and the bottom wall surface of the housing recess 28.

In the sixth embodiment, as in the fifth embodiment, the housing recess 28 is formed in the ultrasonic microphone 20, and the sound vibration sensor 70 is housed in the housing recess 28. Thus, it becomes possible to reduce the thickness of the on-vehicle sensor device 100.

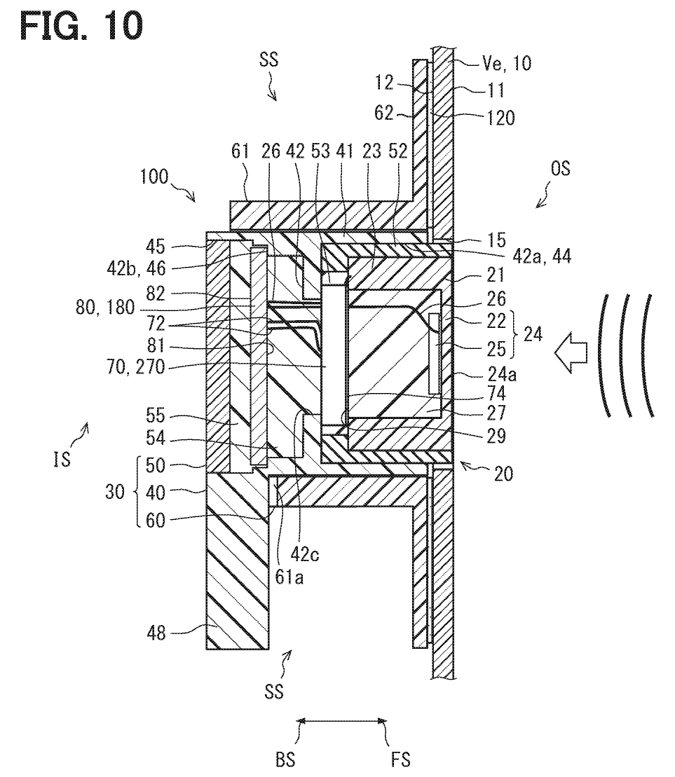

(Seventh Embodiment) An on-vehicle sensor device 100 of the seventh embodiment shown in FIG. 10 is yet another modification of the first embodiment. The sound vibration sensor 70 of the seventh embodiment, similarly to the third embodiment, has a unimorph or bimorph-type diaphragm including the piezoelectric element 270, or a plate-shaped piezoelectric element. The sound vibration sensor 70 is attached to the microphone back surface 29 by a sensor adhesive layer 74. The sensor adhesive layer 74 is formed from double-sided tape or an adhesive. The sound vibration sensor 70 is held on the microphone back surface 29 via the sensor adhesive layer 74.

The back surface of the sound vibration sensor 70 is directly supported by the housing main body 40. The sound vibration sensor 70 is held at the side surface of the intermediate partition wall 42 that faces the front side FS, specifically at the inner edge of the side surface of the intermediate partition wall 42 that faces the connection opening 42c. The sound vibration sensor 70 detects sound or vibration in the audible range that is transmitted from the ultrasonic microphone 20 by the piezoelectric element 270.

In the seventh embodiment, effects similar to those of the first embodiment are achieved, and it becomes possible to simplify the configuration for mounting the sound vibration sensor 70 together with the ultrasonic microphone 20 on the vehicle Ve.

In addition, in the seventh embodiment, the sound vibration sensor 70 is held by the microphone back surface 29 of the ultrasonic microphone 20. With such a configuration, the omission of the air layer 58 (see FIG. 2) becomes possible, allowing for a simplification of the configuration of the on-vehicle sensor device 100.

In the seventh embodiment, the sound vibration sensor 70 is held on the microphone back surface 29 via the sensor adhesive layer 74. With such a configuration, sound or vibration input into the ultrasonic microphone 20 is more easily transmitted to the ultrasonic microphone 20. As a result, it becomes possible to ensure the detection sensitivity of the sound vibration sensor 70.

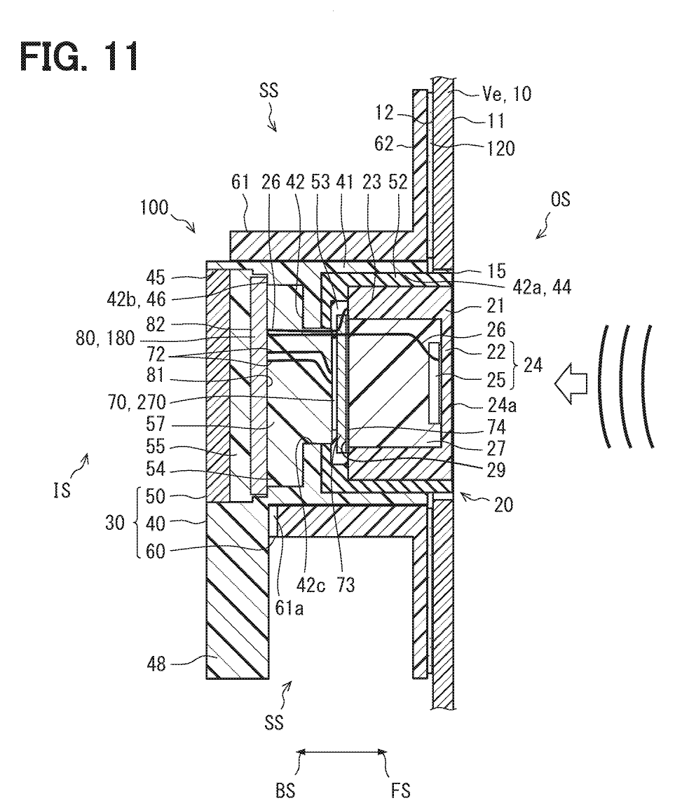

(Eighth Embodiment) An on-vehicle sensor device 100 of the eighth embodiment shown in FIG. 11 is a modification of the seventh embodiment. The sound vibration sensor 70 of the eighth embodiment, like that of the seventh embodiment, has a unimorph or bimorph-type diaphragm formed by laminating the piezoelectric element 270 and the metal plate 73. The sound collecting surface of the sound vibration sensor 70 that faces the front side FS is held on the microphone back surface 29 via the sensor adhesive layer 74. The supported surface of the sound vibration sensor 70 that faces the back side BS is attached to the front surface of the front filler 54 and is fixed to the front filler 54. The sound vibration sensor 70 is indirectly supported by the housing main body 40 via the front filler 54. The sound vibration sensor 70 detects sounds or vibrations in the audible range transmitted from the ultrasonic microphone 20 to the metal plate 73 using the piezoelectric element 270.

Also in the eighth embodiment, the same effects as those of the seventh embodiment are achieved, and it becomes possible to simplify the configuration for mounting the sound vibration sensor 70 together with the ultrasonic microphone 20 in the vehicle Ve. In addition, since the sound vibration sensor 70 is held by the microphone back surface 29 of the ultrasonic microphone 20, the configuration of the on-vehicle sensor device 100 can be simplified.

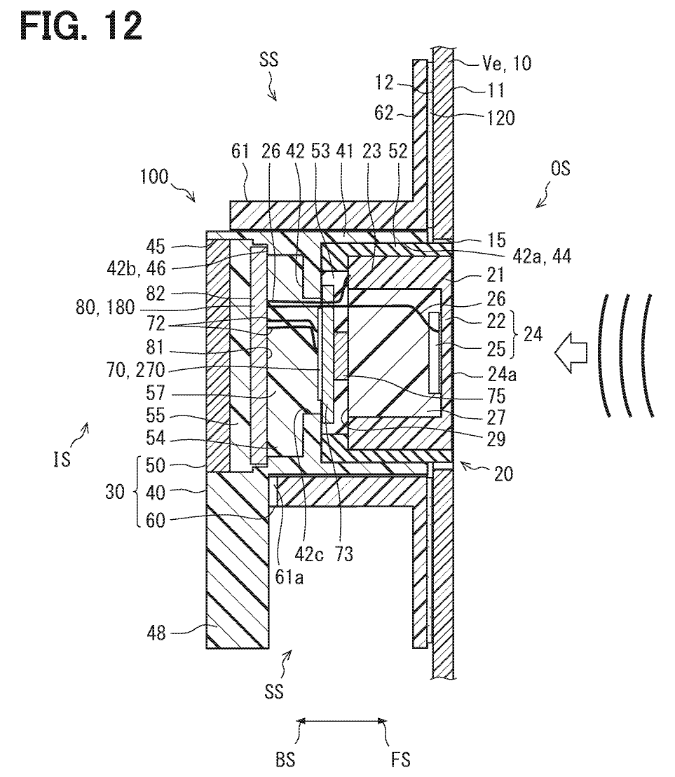

(Ninth Embodiment) An on-vehicle sensor device 100 according to the ninth embodiment shown in FIG. 12 is another modification of the seventh embodiment. In the ninth embodiment, a vibration transmission portion 75 is provided between the microphone back surface 29 and the metal plate 73. The vibration transmission portion 75 is formed into a flat plate shape from a material having a higher modulus of elasticity than the damper 53, such as a metal material (for example, aluminum) or a resin material. The damper 53 may be formed in a partially conical shape, or in a partially pyramidal shape having a trapezoidal vertical cross-section.

Both surfaces of the vibration transmission portion 75 are pressed firmly against the microphone back surface 29 and the metal plate 73, respectively, and are in close contact with the microphone back surface 29 and the metal plate 73 without any gaps. The vibration transmission portion 75 is in contact only with the central portion of the front surface of the sound vibration sensor 70. The vibration transmission portion 75 transmits sounds or vibrations input to the ultrasonic microphone 20 to the metal plate 73.

In the ninth embodiment described above, the same effects as in the seventh embodiment are achieved, and it is possible to simplify the configuration in which the sound vibration sensor 70 is installed together with the ultrasonic microphone 20 in the vehicle Ve. In addition, the configuration in which the vibration transmission portion 75 transmits vibrations from the ultrasonic microphone 20 to the sound vibration sensor 70 improves the detection sensitivity of the sound vibration sensor 70.

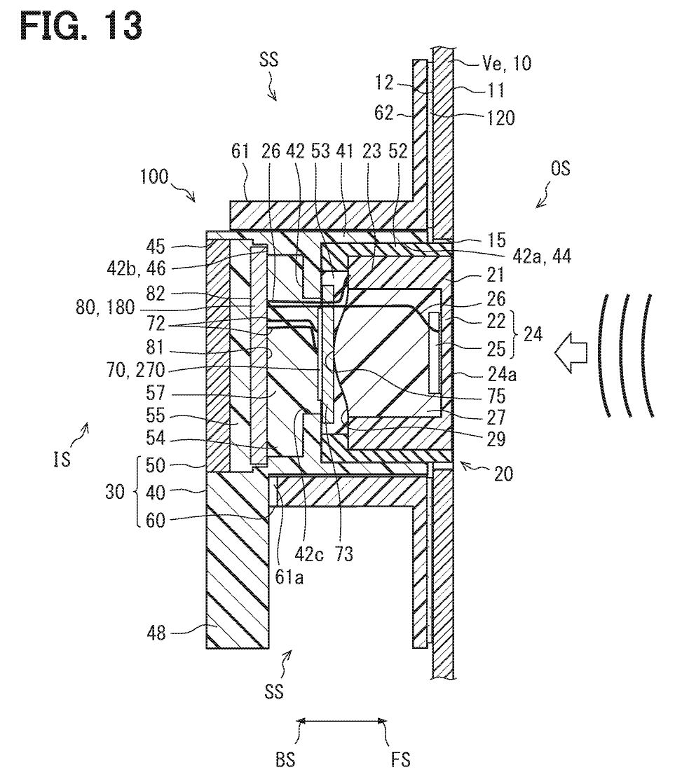

(Tenth Embodiment) An on-vehicle sensor device 100 of the tenth embodiment shown in FIG. 13 is a modified example of the ninth embodiment. The ultrasonic microphone 20 of the tenth embodiment has a vibration transmission portion 75. The vibration transmission portion 75 is formed by the microphone filler 27. The vibration transmission portion 75 is a protrusion that protrudes from the center portion of the microphone back surface 29 toward the back side BS. The tip end of the vibration transmission portion 75 is pressed against the center portion of the metal plate 73. Sound or vibration input to the ultrasonic microphone 20 is transmitted to the metal plate 73 via the vibration transmission portion 75.

In the tenth embodiment, the same effects as in the ninth embodiment are achieved, and it becomes possible to simplify the configuration in which the sound vibration sensor 70 is mounted together with the ultrasonic microphone 20 on the vehicle Ve. In addition, the configuration where the vibration transmission portion 75 provided on the microphone back surface 29 transmits vibrations to the sound vibration sensor 70 improves the detection sensitivity of the sound vibration sensor 70.

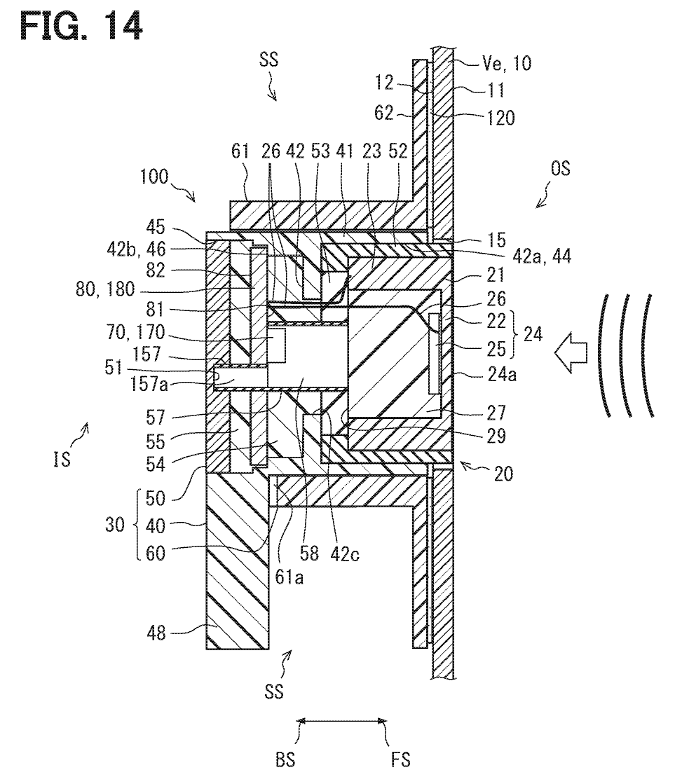

(Eleventh Embodiment) An on-vehicle sensor device 100 of the eleventh embodiment shown in FIG. 14 is yet another modification of the first embodiment. The on-vehicle sensor device 100 includes a back sound duct 157. The back sound duct 157 is integrally formed with the viscoelastic tube 57. The back sound duct 157 is formed in a cylindrical shape. The back sound duct 157 penetrates the circuit board 80 in the board thickness direction and defines a cylindrical back sound space 157a that extends from the air layer 58 to the back side BS. The end of the back sound duct 157 facing the back side BS is fitted inside a sound guiding recess 51 formed in the back cover 50. The sound guiding recess 51 forms a thin plate portion in the back cover 50.

With the above configuration, sound and vibrations generated in the inner space IS are transmitted to the air layer 58 through the thin plate portion and the back sound space 157a. As a result, the sound vibration sensor 70 can detect not only sound or vibrations generated in the outer space OS, but also sound or vibrations (for example, engine noise, motor noise, etc.) generated in the inner space IS.

In the eleventh embodiment, the same effects as those of the first embodiment are achieved, and the structure for mounting the sound vibration sensor 70 together with the ultrasonic microphone 20 on the vehicle Ve can be simplified.

In addition, the on-vehicle sensor device 100 according to the eleventh embodiment includes the cylindrical back sound duct 157. The back sound duct 157 introduces sound or vibrations from the inner space IS, located on the back side BS of the housing main body 40, into the air layer 58. According to the above, detection of sound or vibrations in the inner space IS can be achieved without increasing the number of sound vibration sensors 70 provided in the on-vehicle sensor device 100. In the eleventh embodiment, the back sound duct 157 corresponds to the "sound guiding tube."

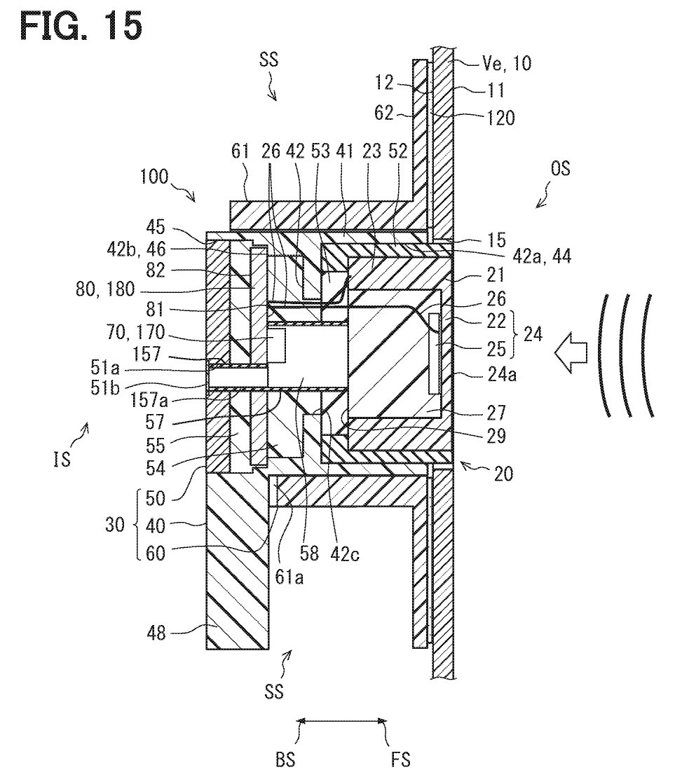

(Twelfth Embodiment) An on-vehicle sensor device 100 of the twelfth embodiment shown in FIG. 15 is a modification of the eleventh embodiment. In the twelfth embodiment, the back cover 50 defines a sound guiding opening 51a instead of the sound guiding recess 51 (see FIG. 14). The sound guiding opening 51a is a through-hole that passes through the back cover 50 in the plate thickness direction of the back cover 50. The end portion of the back sound duct 157 is fitted inside the sound guiding opening 51a. The sound guiding opening 51a and the back sound space 157a are sealed from the back side BS by a sound guiding membrane 51b. The sound guiding membrane 51b is formed as a thin film from a water proof material that allows sounds and vibrations to pass therethrough (for example, GORE-TEX®, registered trademark).

Also in the twelfth embodiment, the same effects as in the eleventh embodiment are achieved, and it becomes possible to simplify the configuration for mounting the sound vibration sensor 70 together with the ultrasonic microphone 20 on the vehicle Ve. In addition, in the twelfth embodiment, sound or vibration generated in the inner space IS is transmitted to the air layer 58 via the sound guiding membrane 51b and the back sound space 157a. Accordingly, it becomes possible to detect sound or vibration in the inner space IS without increasing the number of sound vibration sensors 70.

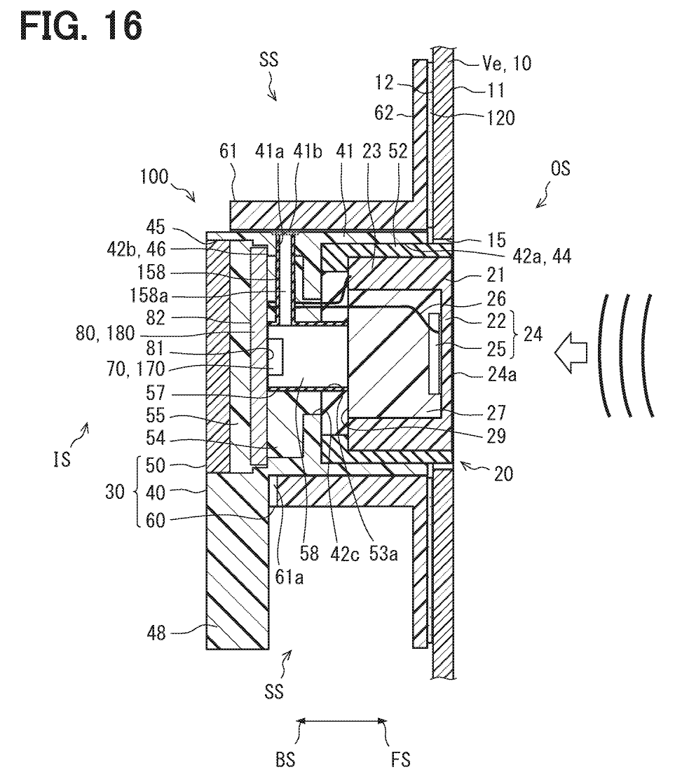

(Thirteenth Embodiment) An on-vehicle sensor device 100 of the thirteenth embodiment shown in FIG. 16 is another modification of the eleventh embodiment. The on-vehicle sensor device 100 includes a lateral sound guiding tube 158. The lateral sound guiding tube 158 is integrally formed with the viscoelastic tube 57. The lateral sound guiding tube 158 is formed in a cylindrical shape. The lateral sound guiding tube 158 defines a cylindrical lateral sound guiding space 158a that extends from the air layer 58 toward the housing peripheral wall 41. The end of the lateral sound guiding tube 158 opposite to the air layer 58 is fitted inside a sound guiding opening 41a defined in the housing peripheral wall 41. The sound guiding opening 41a and the lateral sound guiding space 158a are sealed from the outer peripheral side by a sound guiding membrane 41b. The sound guiding membrane 41b, like the sound guiding membrane 51b of the twelfth embodiment (see FIG. 15), is made of a material that transmits both sound and vibration.

The thirteenth embodiment also achieves the same effects as the eleventh embodiment, and enables simplification of the configuration for mounting the sound vibration sensor 70 together with the ultrasonic microphone 20 on the vehicle Ve.

In addition, the on-vehicle sensor device 100 according to the thirteenth embodiment is provided with the lateral sound guiding tube 158. The lateral sound guiding tube 158 introduces sound or vibration from the side space SS, which is located on the side of the housing main body 40, into the air layer 58. According to the above, it is possible to detect sound or vibration in the side space SS without increasing the number of sound vibration sensors 70 provided in the on-vehicle sensor device 100. In the thirteenth embodiment, the lateral sound guiding tube 158 corresponds to a "sound guiding tube."

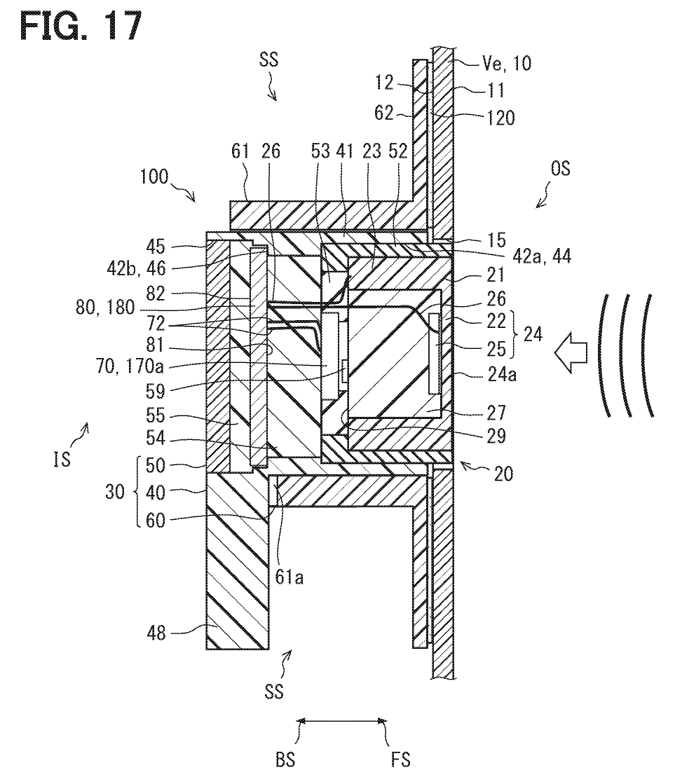

(Fourteenth Embodiment) An on-vehicle sensor device 100 of the fourteenth embodiment shown in FIG. 17 is another modified example of the second embodiment. The on-vehicle sensor device 100 includes a moisture absorbent 59 in the air layer 58. The moisture absorbent 59 is formed into a chip shape and is attached to the microphone back surface 29. The moisture absorbent 59 absorbs water vapor generated in the air layer 58 and suppresses the occurrence of condensation in the air layer 58.

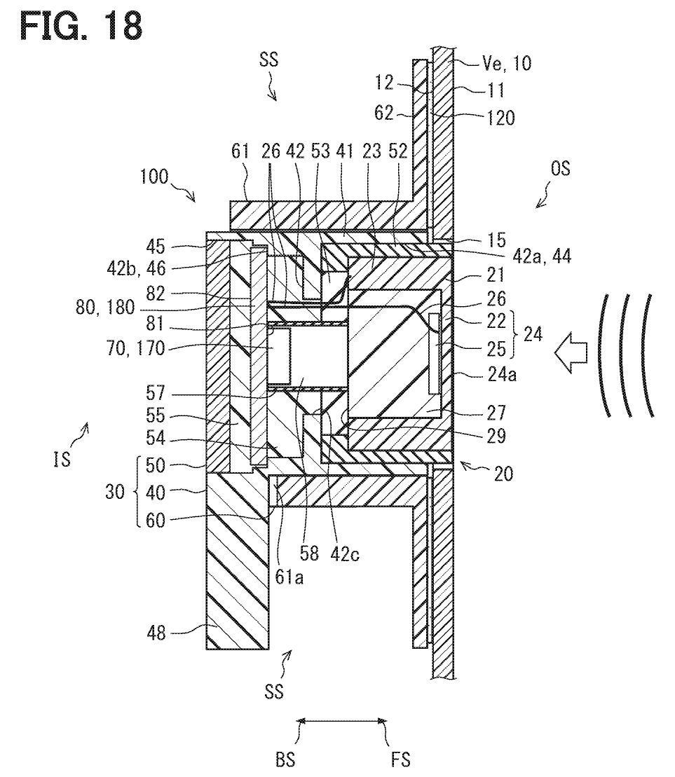

(Fifteenth Embodiment) An on-vehicle sensor device 100 of the fifteenth embodiment shown in FIG. 18 is yet another modification of the first embodiment. In the fifteenth embodiment, the moisture absorbent 59 is omitted. As described above, the presence or absence of the moisture absorbent 59 may be appropriately changed as needed.

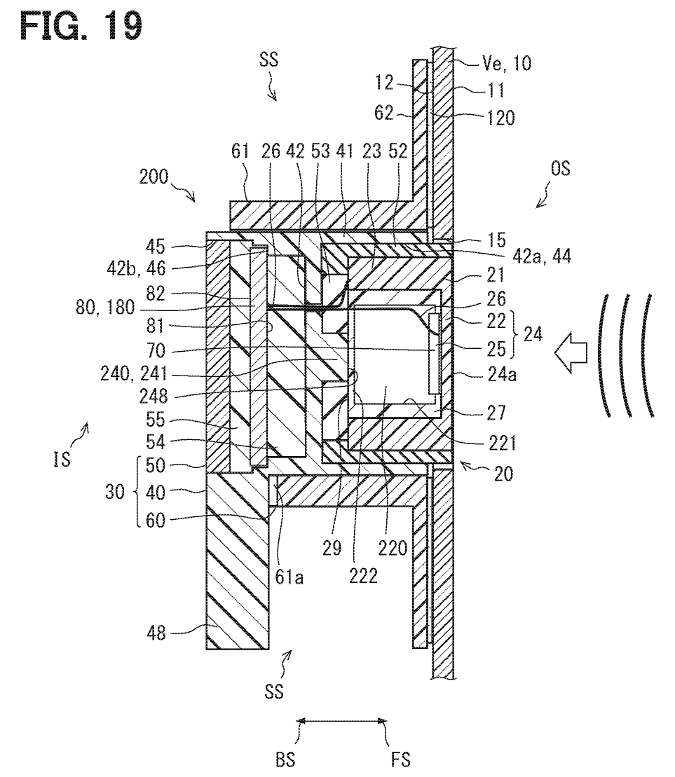

(Sixteenth Embodiment) An on-vehicle sensor device 200 of the sixteenth embodiment shown in FIG. 19 is yet another modification of the first embodiment. In the on-vehicle sensor device 200, the transceiver 24 is shared with the sound vibration sensor 70. More specifically, the piezoelectric element 25 constituting the transceiver 24 serves also as the sound vibration sensor 70 by detecting not only ultrasonic waves but also audible sound and vibrations. The following describes in detail the ultrasonic microphone 20 and the housing main body 40 of the housing included in the on-vehicle sensor device 200 of the sixteenth embodiment.

The ultrasonic microphone 20 includes a compartment housing 221 and a diaphragm 222. The compartment housing 221 is formed in a bottomed cylindrical shape from a metal material such as aluminum or a resin material such as silicone rubber. The compartment housing 221 is housed inside the microphone housing 21 with the thin, plate-shaped bottom wall of the compartment housing 221 faces the back side BS. The compartment housing 221 and the microphone housing 21 define an internal microphone space 220 within the ultrasonic microphone 20.

The internal microphone space 220 is located on the back side BS of the piezoelectric element 25 and is a sealed and airtight hollow space facing the piezoelectric element 25. The back surface of the piezoelectric element 25 is exposed to the internal microphone space 220. The piezoelectric element 25 detects not only vibrations generated at the receiving bottom portion 22 but also pressure fluctuations occurring within the internal microphone space 220.

The diaphragm 222 is formed in the central portion of the microphone back surface 29. The diaphragm 222 can elastically deform in the thickness direction with the hollow internal microphone space 220 defined within the microphone filler 27. When the diaphragm 222 deforms in the thickness direction, pressure fluctuations occur within the internal microphone space 220.

The housing main body 40, as in the first embodiment and the like, supports the ultrasonic microphone 20 such that the ultrasonic microphone 20 can displace by sound or vibration in the audible range. The ultrasonic microphone 20 is elastically supported via the cushion 52 and the damper 53, allowing the ultrasonic microphone 20 to be slightly displaced along the axial direction of the housing peripheral wall 41. The housing main body 40 includes a compressing portion 240 that compresses the internal microphone space 220 by displacement of the ultrasonic microphone 20.

The compressing portion 240 is formed by a compression protrusion 241. The compression protrusion 241 is formed at the central portion of one of the side surfaces of the intermediate partition wall 42 that faces the front side FS. The compression protrusion 241 protrudes from the intermediate partition wall 42 toward the front side FS, with its top surface in contact with the diaphragm 222. The compression protrusion 241 serves as a pressing surface 248 that directly presses the diaphragm 222.

According to the above configuration, when the ultrasonic microphone 20 is displaced by sound or vibration in the audible range input to the ultrasonic microphone 20, the diaphragm 222, which is in contact with the pressing surface 248, vibrates. As a result, pressure fluctuations occur in the internal microphone space 220, enabling the piezoelectric element 25 to measure sound or vibration in the audible range by detecting the generated pressure fluctuations.

In the sixteenth embodiment described above, the same effects as in the first embodiment are achieved, enabling simplification of the configuration in which the ultrasonic microphone 20 and the sound vibration sensor 70 are installed together in the vehicle Ve.

In addition, in the ultrasonic microphone 20 of the sixteenth embodiment, the internal microphone space 220, which faces the transceiver 24 is defined on the back side BS of the transceiver 24. Further, the sensor housing 30 supports the ultrasonic microphone 20 such that the ultrasonic microphone 20 can displace by sound or vibration in the audible range. Furthermore, the compressing portion 240 that compresses the internal microphone space 220 by displacement of the ultrasonic microphone 20 is provided inside the sensor housing 30. The piezoelectric element 25 of the transceiver 24 is shared with the sound vibration sensor 70. With the above configuration, since the piezoelectric element 25 also serves as the sound vibration sensor 70, it becomes possible to further simplify the structure of the on-vehicle sensor device 200. In the sixteenth embodiment, the internal microphone space 220 corresponds to a "hollow space."

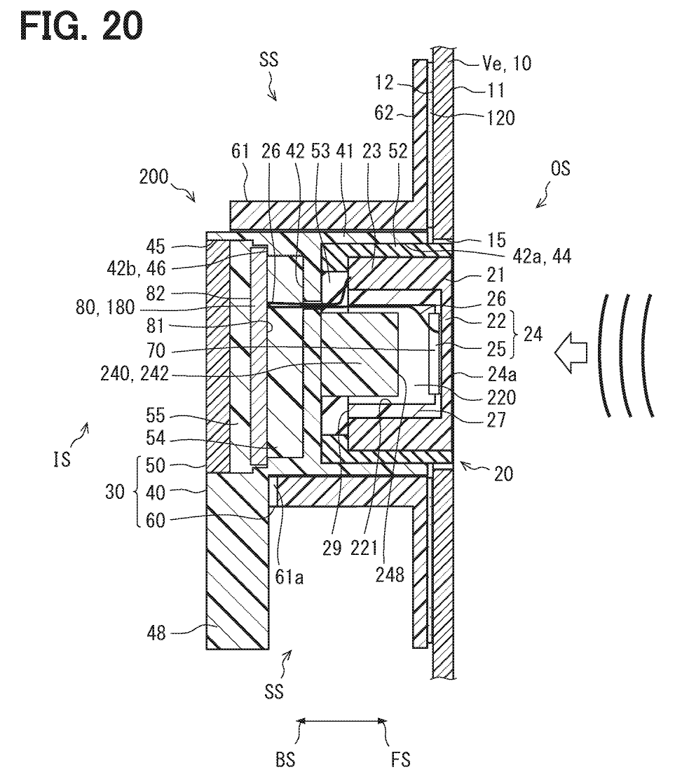

(Seventeenth Embodiment) An on-vehicle sensor device 200 of the seventeenth embodiment shown in FIG. 20 is a modification of the sixteenth embodiment. In the ultrasonic microphone 20 of the seventeenth embodiment, the component corresponding to the diaphragm 222 (see FIG. 19) is omitted. The internal microphone space 220 is defined as a generally airtight space by the compartment housing 221, the damper 53, and a compression piston portion 242.

The compression piston portion 242 corresponds to the compression protrusion 241 (see FIG. 19). The compression piston portion 242 is formed in a cylindrical or prismatic shape from a metal material or a resin material. The compression piston portion 242 is fixed at the central part of one of the side surfaces of the intermediate partition wall 42 that faces the front side FS. Most of the compression piston portion 242 is housed within the internal microphone space 220. The compression piston portion 242 has a top surface (pressing surface 248) facing the front side FS, which faces the back surface of the piezoelectric element 25. The outer surface of the compression piston portion 242 faces the inner surface of the compartment housing 221 with a slight gap therebetween.

According to the above configuration, when the ultrasonic microphone 20 is displaced by audible sound or vibration input into the ultrasonic microphone 20, the distance between the pressing surface 248 and the piezoelectric element 25 increases or decreases. As a result, pressure fluctuations occur within the internal microphone space 220, enabling the piezoelectric element 25 to detect these pressure fluctuations and thereby measure audible sound or vibration.

In the seventeenth embodiment described above, the same effects as those of the sixteenth embodiment are achieved, and it is possible to simplify the configuration in which the ultrasonic microphone 20 and the sound vibration sensor 70 are mounted together on the vehicle Ve. In addition, in the seventeenth embodiment, since the piezoelectric element 25 also serves as the sound vibration sensor 70, the configuration of the on-vehicle sensor device 200 can be further simplified.

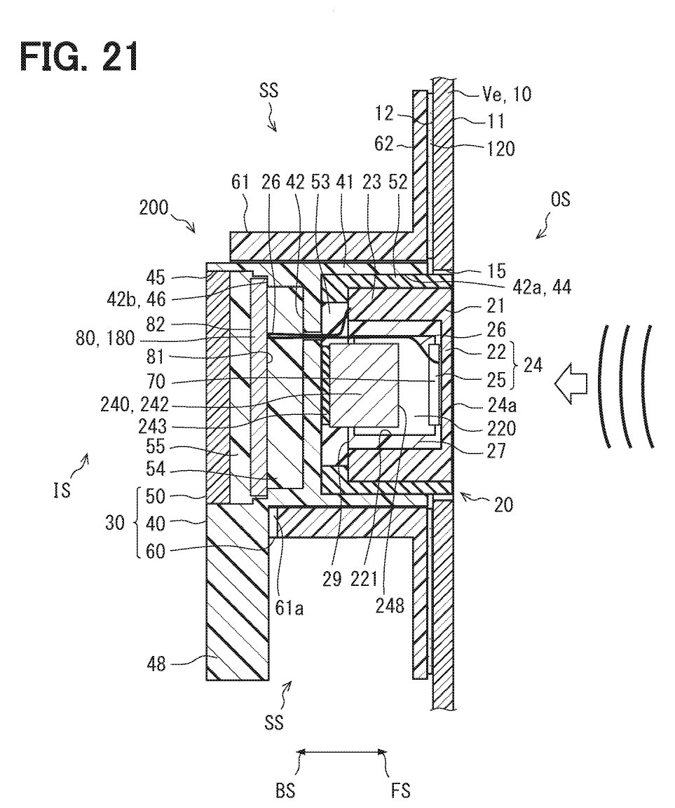

(Eighteenth Embodiment) An on-vehicle sensor device 200 of the eighteenth embodiment shown in FIG. 21 is a modified example of the seventeenth embodiment. The compression piston portion 242 of the eighteenth embodiment is provided to be slidable with respect to the compartment housing 221. The internal microphone space 220 is partitioned as a generally airtight space by the compartment housing 221 and the compression piston portion 242.

The compression piston portion 242 is held on the intermediate partition wall 42 via a bush 243. The bush 243 is formed in a thin plate shape from silicone rubber or the like. When the ultrasonic microphone 20 is displaced by audible sound or vibration, the compression piston portion 242 increases the pressure within the internal microphone space 220 via the pressing surface 248. By detecting such pressure fluctuations, the piezoelectric element 25 is able to measure audible sounds or vibrations.

The eighteenth embodiment described above achieves the same effects as the seventeenth embodiment, and similarly enables simplification of the configuration for mounting the sound vibration sensor 70 together with the ultrasonic microphone 20 on the vehicle Ve. In addition, in the eighteenth embodiment, since the piezoelectric element 25 also serves as the sound vibration sensor 70, the configuration of the on-vehicle sensor device 200 can be further simplified.

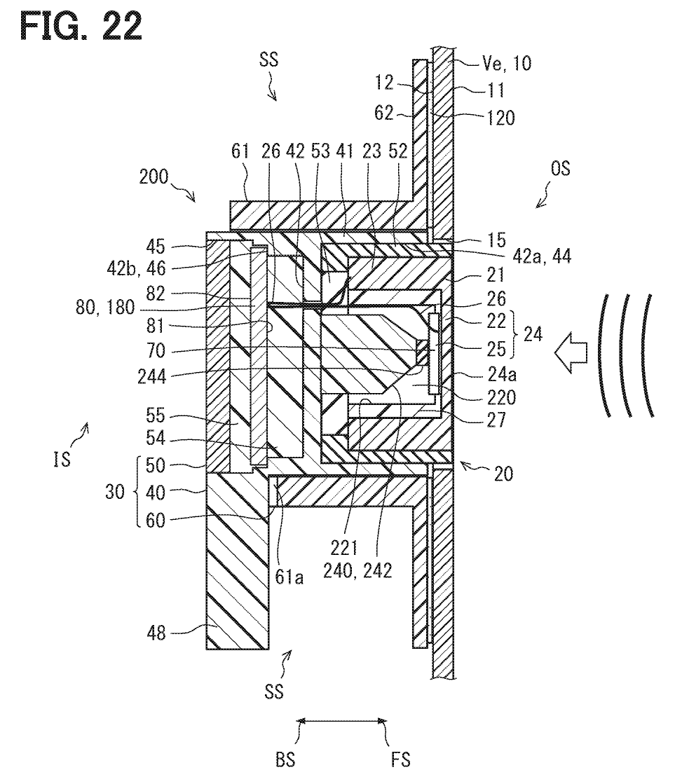

(Nineteenth Embodiment) An on-vehicle sensor device 200 of the nineteenth embodiment shown in FIG. 22 is another modification of the seventeenth embodiment. The compression piston portion 242 of the nineteenth embodiment includes a contact point 244. The contact point 244 is formed in a plate shape using rubber or double-sided tape. The contact point 244 is attached to the tip end of the compression piston portion 242, which protrudes from the intermediate partition wall 42 toward the front side FS. The compression piston portion 242 is in indirect contact with the back surface of the piezoelectric element 25 via the contact point 244.

The compression piston portion 242 has a back surface that faces the back side BS and is directly fixed to the intermediate partition wall 42. Most of the front portion of the compression piston portion 242 facing the front side FS is accommodated within the internal microphone space 220. The internal microphone space 220 is a space that is open to the back side BS. The compression piston portion 242 is inserted into the internal microphone space 220 through an opening formed in the bottom wall of the compartment housing 221.

According to the above configuration, when the ultrasonic microphone 20 is displaced by audible sound or vibration input to the ultrasonic microphone 20, the compression piston portion 242, which is fixed relative to the housing main body 40, presses the piezoelectric element 25 via the contact point 244. The piezoelectric element 25 is able to measure audible sounds or vibrations by detecting vibrations input via the contact point 244.

In the nineteenth embodiment described above, the same effects as in the seventeenth embodiment are achieved, and it becomes possible to simplify the configuration for mounting the sound vibration sensor 70 together with the ultrasonic microphone 20 on the vehicle Ve. In addition, in the nineteenth embodiment as well, since the piezoelectric element 25 also serves as the sound vibration sensor 70, the configuration of the on-vehicle sensor device 200 can be further simplified.

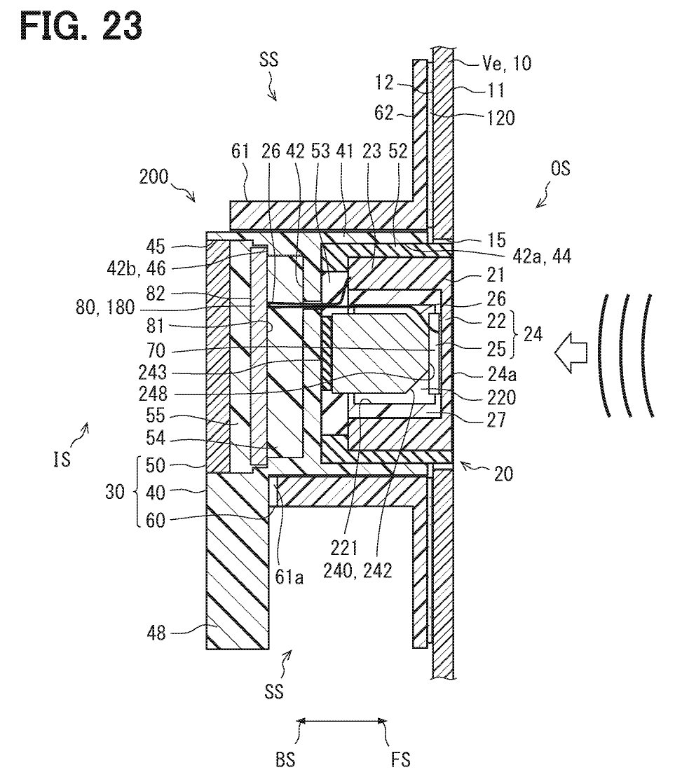

(Twentieth Embodiment) An on-vehicle sensor device 200 of the twentieth embodiment shown in FIG. 23 is a modification of the nineteenth embodiment. In the on-vehicle sensor device 200 of the twentieth embodiment, the compression piston portion 242 is indirectly supported by the intermediate partition wall 42. The back surface of the compression piston portion 242 is fixed relative to the central portion of the intermediate partition wall 42 via a bush 243. The bush 243 is formed in a plate shape from rubber or double-sided tape. The compression piston portion 242 has a pressing surface 248 facing the front side FS, which is in contact with the back surface of the piezoelectric element 25. When the ultrasonic microphone 20 is displaced by audible sound or vibration, the compression piston portion 242 presses the piezoelectric element 25 with the pressing surface 248. As a result, the piezoelectric element 25 can measure audible sound or vibration.

In the twentieth embodiment described above, effects similar to those of the nineteenth embodiment are achieved, and it becomes possible to simplify the configuration for installing the sound vibration sensor 70 together with the ultrasonic microphone 20 on the vehicle Ve. In addition, in the twentieth embodiment as well, since the piezoelectric element 25 also serves as the sound vibration sensor 70, the configuration of the on-vehicle sensor device 200 can be further simplified.

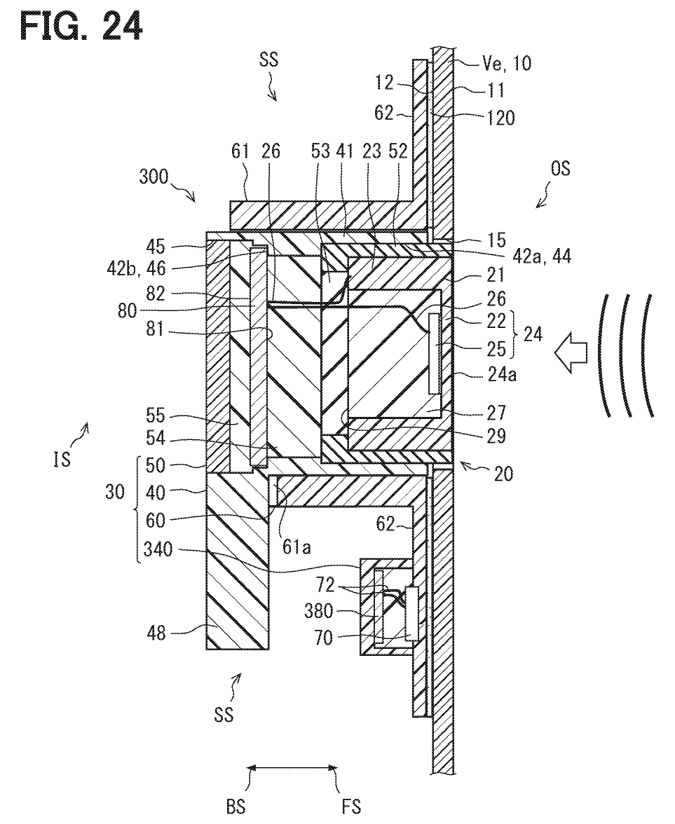

(Twenty-first Embodiment) An on-vehicle sensor device 300 of the twenty-first embodiment shown in FIG. 24 is yet another modification of the first embodiment. The sensor housing 30 of the on-vehicle sensor device 300 includes a sub-housing 340 in addition to the housing main body 40, the back cover 50, and the retainer 60. The sub-housing 340 is provided on the back side BS of the retaining portion 62 of the retainer 60. The sub-housing 340 houses the sound vibration sensor 70 and a sub-board 380. The sound vibration sensor 70 is electrically connected to the sub-board 380 via sensor lead wires 72.

In the on-vehicle sensor device 300 according to the twenty-first embodiment described above, the same effects as those of the first embodiment are achieved, and it is possible to simplify the configuration in which the sound vibration sensor 70 is installed in the vehicle Ve together with the ultrasonic microphone 20. The audible sound microphone element of the sound vibration sensor 70 housed in the sub-housing 340 may be appropriately selected from among an audible sound microphone element of the MEMS microphone 170, an electret condenser microphone, and a piezoelectric element 270.

(Other Embodiments) The above has described multiple embodiments of the present disclosure, but the present disclosure is not to be construed as being limited to the above embodiments, and it can be applied to various embodiments and combinations without departing from the spirit of the present disclosure.

In the above embodiment, the transceiver 24 is configured to perform both reception and transmission of ultrasonic waves. However, the transceiver 24 may be configured to perform only one of reception or transmission of ultrasonic waves. Further, the sound vibration sensor 70 may be configured to detect only one of audible sound and vibration.

The sensor housing 30 may not include the retainer 60. In such a configuration, a structure corresponding to the retaining portion 62 is provided on the housing main body 40. The housing main body 40 is directly fixed to the vehicle inner surface 12 by the retaining portion 62 and the adhesive layer 120.

The vehicle Ve equipped with the on-vehicle sensor device 100 is not limited to a typical private passenger car, but may also be a vehicle for rental use, a vehicle for manned taxi service, a vehicle for ride-sharing, a cargo vehicle, a bus, or the like. Furthermore, the on-vehicle sensor device 100 can also be mounted on vehicles dedicated to unmanned driving used for mobility services. In addition, the number and installation positions of the on-vehicle sensor devices 100 are appropriately optimized according to the type of vehicle Ve, the purpose of vehicle Ve, and the traffic environment and regulations, etc., of the country or region where the vehicle Ve is used.

In the above embodiments, the respective functions provided by the signal processing circuit 180 and the ECU 90 can also be implemented by software and hardware that executes it, by software alone, by hardware alone, or by a combination thereof. Furthermore, when such functions are provided by electronic circuits as hardware, each function can be implemented by digital circuits including a large number of logic circuits, or by analog circuits.

(Disclosure of Technical Concept) This specification also encompasses technical concepts described in the following enumerated items.

An on-vehicle sensor device to be mounted on a vehicle includes an ultrasonic sensor, and a sound vibration sensor. The ultrasonic sensor includes a transceiver configured to perform at least one of reception or transmission of an ultrasonic wave. The sound vibration sensor detects a sound or vibration in an audible range. A first connection line through which the sound vibration sensor is electrically connected to an external device is also used as a second connection line through which the ultrasonic sensor is electrically connected to the external device. The external device is disposed outside the sensor housing.

An on-vehicle sensor device to be mounted on a vehicle includes an ultrasonic sensor, a sensor housing, and a compressing portion. The ultrasonic sensor includes a transceiver configured to perform at least one of reception or transmission of an ultrasonic wave, and defines a hollow space facing the transceiver on a back side of the transceiver. The sensor housing houses at least a part of the ultrasonic sensor, and supports the ultrasonic sensor to allow displacement of the ultrasonic sensor due to a sound or vibration within an audible range. The compressing portion is disposed in the sensor housing and configured to compress the hollow space by the displacement of the ultrasonic sensor.

1. An on-vehicle sensor device to be mounted on a vehicle, the on-vehicle sensor device comprising:
an ultrasonic sensor that includes a transceiver configured to perform at least one of reception or transmission of an ultrasonic wave;
a sensor housing that houses at least a part of the ultrasonic sensor; and
a sound vibration sensor that is configured to detect a sound or vibration in an audible range, wherein
the sensor housing houses the sound vibration sensor in addition to the ultrasonic sensor,
the sound vibration sensor is disposed separately from the transceiver on a back side of the transceiver, and
the sensor housing defines a hollow space between the sound vibration sensor and the transceiver.

2. The on-vehicle sensor device according to claim 1, further comprising
a sensor substrate housed in the sensor housing, wherein
the sound vibration sensor includes a MEMS microphone that is mounted on a surface of the sensor substrate.

3. The on-vehicle sensor device according to claim 2, further comprising
a viscoelastic tube formed into a tubular shape with a viscoelastic material, wherein
the viscoelastic tube defines therein the hollow space between the sensor substrate and the transceiver.

4. The on-vehicle sensor device according to claim 1, further comprising
a filling covering that covers the back side of the transceiver, wherein
the filling covering includes a recess that defines at least a part of the hollow space.

5. The on-vehicle sensor device according to claim 1, further comprising
a moisture absorbent disposed in the hollow space to absorb water vapor in the hollow space.

6. The on-vehicle sensor device according to claim 1, further comprising
a sound guiding tube through which the sound or vibration is guided into the hollow space from at least one of an inner space defined on a back side of the sensor housing and a side space defined on a lateral side of the sensor housing.

7. The on-vehicle sensor device according to claim 1, wherein
the sound vibration sensor is supported by a back surface of the ultrasonic sensor.

8. The on-vehicle sensor device according to claim 7, wherein
the sound vibration sensor is supported by the back surface through a sensor adhesive layer.

9. The on-vehicle sensor device according to claim 1, wherein
the sound vibration sensor is directly or indirectly supported by the sensor housing.

10. The on-vehicle sensor device according to claim 1, wherein
a first connection line through which the sound vibration sensor is electrically connected to an external device is also used as a second connection line through which the ultrasonic sensor is electrically connected to the external device, the external device being disposed outside the sensor housing.

11. The on-vehicle sensor device according to claim 1, further comprising
an output converter configured to convert an output signal from the sound vibration sensor to feature quantity information, the feature quantity information being to be transmitted to an external device outside the sensor housing.

12. An on-vehicle sensor device to be mounted on a vehicle, the on-vehicle sensor device comprising:
an ultrasonic sensor that includes a transceiver configured to perform at least one of reception or transmission of an ultrasonic wave;
a sensor housing that houses at least a part of the ultrasonic sensor; and
a sound vibration sensor that is configured to detect a sound or vibration in an audible range, wherein
the sensor housing houses the sound vibration sensor in addition to the ultrasonic sensor,
the ultrasonic sensor defines a hollow space facing a back surface of the transceiver,
the sensor housing supports the ultrasonic sensor to allow displacement of the ultrasonic sensor due to the sound or vibration within the audible range,
the sensor housing includes therein a compressing portion configured to compress the hollow space by the displacement of the ultrasonic sensor, and
the sound vibration sensor uses the transceiver of the ultrasonic sensor as a transceiver for the sound vibration sensor.
